(19) United States
(12) Patent Application Publication
(10) Pub. No.: US 2026/0025205 A1
(43) Pub. Date: Jan. 22, 2026

(54) OPTICAL TRANSMISSION LINE, OPTICAL TRANSMISSION SYSTEM, AND METHOD OF CONNECTING OPTICAL TRANSMISSION LINES

(71) Applicant: Yasuhiro KOIKE, Yokohama-shi (JP)

(72) Inventors: Yasuhiro KOIKE, Kanagawa (JP); Kenta MURAMOTO, Kanagawa (JP)

(73) Assignee: Yasuhiro KOIKE, Yokohama-shi (JP)

(21) Appl. No.: 18/994,686

(22) PCT Filed: Jul. 28, 2022
(86) PCT No.: PCT/JP2022/029167

§ 371 Date: Jan. 15, 2025

(51) Int. Cl. H04B 10/2507; G02B 6/38; H04B 10/516

(52) U.S. Cl. CPC H04B 10/2507; G02B 6/3874; H04B 10/516

(57) ABSTRACT

An optical transmission system includes: a first optical transmission line to which an optical signal having a predetermined wavelength is input; a second optical transmission line; and a connection portion that optically connects the first optical transmission line with the second optical transmission line, in which, when a product of a scattering loss of the optical signal and a length is 6 dB or less and a Gaussian beam emitted from a single-mode optical fiber is input by center excitation, the first optical transmission line performs output while enlarging a beam diameter by three times or more, and in the connection portion, the first optical transmission line and the second optical transmission line are optically connected via a gap.

### FIELD

The present invention relates to an optical transmission line, an optical transmission system, and a method of connecting optical transmission lines.

### BACKGROUND

In an optical transmission system, connecting and disconnecting optical transmission lines such as optical fiber cables are essential for constructing a device. Therefore, a connection portion of the optical transmission line, such as an optical fiber connector, is an important element for constituting the optical transmission system together with the optical transmission line and a light source/light receiver.

When optical fibers are connected to each other, reflection generated in a connection portion of the optical fibers causes an increase in reflection loss and reflected return light noise. Therefore, inhibiting the reflection in the connection portion is important for performing high-quality optical transmission. Examples of a method of inhibiting reflection in a connection portion include a method using a refractive index matching agent and an antireflection coating. A physical contact (PC) connection is, however, most widely used. In the PC connection, both end surfaces of optical fibers are brought into physical contact with each other to prevent reflection. In addition, a method of obliquely polishing an end surface of an optical fiber is used for inhibiting reflected return light.

In the PC connection, end surfaces of optical fibers, which have been polished to have convex spherical surfaces (PC-polished), are pressed against and brought into close contact with each other to prevent occurrence of reflection. Not only precise polishing on a connector end surface but strong fitting force at the time of connection are, however, necessary for performing the PC connection, which may cause problems of a deterioration in workability and an increase in cost due to ruggedization of a connector. Moreover, since end surfaces of optical fibers are brought into physical contact with each other in the PC connection, a foreign substance may be pressed against the end surfaces to damage the end surfaces when fitting is performed with the foreign substance being on an end surface.

In consideration of application of an optical fiber to consumer equipment (e.g., a smartphone, a personal computer, a television monitor, and augmented reality (AR)/virtual reality (VR)), the optical fiber is assumed to be frequently inserted and removed in the application. If the PC connection is adopted in such a case, an end surface of an optical fiber is damaged each time connection is made, which may greatly damage reliability of optical connection.

Furthermore, using the PC connection may cause a problem also in an in-vehicle network application of an optical fiber. That is, in an in-vehicle environment, vibration is constantly applied to elements constituting a network. If the PC connection is adopted in such a situation, the end surface of the optical fiber may be damaged by wear.

Furthermore, in recent years, in an application requiring a high data rate such as a data center, multi-core optical links have been increasingly adopted in which data is transmitted in parallel by using a plurality of optical fibers. A multi-core optical connector capable of collectively connecting a plurality of optical fibers is used for connecting the multi-core optical links. In particular, multi-fiber push-on (MPO) connectors are most widely used.

The MPO connectors are designed such that distal ends of all optical fibers protrude from connector end surfaces (ferrule end surfaces). The mechanism causes end surfaces of optical fibers to be brought into physical contact with each other at the time when the MPO connectors are fitted to each other, and the PC connection can be achieved.

Here, the optical fibers can be made to protrude by using a ferrule having a lower hardness than the optical fibers at the time of polishing the connectors. Precisely controlling amounts of protrusions of optical fibers in an actual polishing process is, however, difficult, and the protrusion amounts vary more than a little. Furthermore, an angular defect state may occur accompanying polishing. In the angular defect state, for example, the ferrule end surface may be obliquely polished. Since such an irregular connector structure may cause an unintended gap between optical fibers. It is thus difficult to simultaneously achieve precise PC connection at connection portions of all the optical fibers of the MPO connectors. Therefore, in a process of producing an MPO connector, a problem of an increase in cost may arise due to a decrease in a yield rate in a polishing process.

### CITATION LIST

### Patent Literature

Patent Literature 1: International Application PCT/JP 2022/006478

### SUMMARY

### Technical Problem

As described above, there is room for improvement regarding connectivity of an optical transmission line.

In contrast, the present inventor has proposed a technique capable of achieving high-quality and large-capacity communication with a simple configuration in Patent Literature 1, and has found a technique capable of improving connectivity in an optical transmission line in relation to the technique.

The present invention has been made in view of the above, and an object thereof is to provide an optical transmission line, an optical transmission system, and a method of connecting optical transmission lines having improved connectivity and capable of achieving high-quality and large-capacity communication with a simple configuration.

### Solution to Problem

To address the problem and attain the object, according to an aspect of the present invention, an optical transmission line includes: a first optical transmission line to which an optical signal having a predetermined wavelength is input; a second optical transmission line; and a connection portion that optically connects the first optical transmission line with the second optical transmission line. Further, when a product of a scattering loss of the optical signal and a length is 6 dB or less and a Gaussian beam emitted from a single-mode optical fiber is input by center excitation, the first optical transmission line performs output while enlarging a beam diameter by three times or more, and in the connection portion, the first optical transmission line and the second optical transmission line are optically connected via a gap.

According to an aspect of the present invention, an optical transmission system includes the optical transmission line.

According to an aspect of the present invention a method of optically connecting a first optical transmission line, to which an optical signal having a predetermined wavelength is input, with a second optical transmission line, includes: by the first optical transmission line, when a product of a scattering loss of the optical signal and a length is 6 dB or less and a Gaussian beam emitted from a single-mode optical fiber is input by center excitation, performing output while enlarging a beam diameter by three times or more; and optically connecting the first optical transmission line with the second optical transmission line via a gap.

### Advantageous Effects of Invention

According to the present invention, an effect of achieving high connectivity and high-quality and large-capacity communication with a simple configuration is exhibited.

### BRIEF DESCRIPTION OF DRAWINGS

FIG. 1 is a schematic configuration diagram of an optical transmission line according to a first embodiment.

FIG. 2 is a cross-sectional view of a connection portion in FIG. 1.

FIG. 3 illustrates a method of measuring beam characteristics.

FIG. 4 illustrates measurement results of the beam characteristics of outputs of a DBR laser, a first optical transmission line of Comparative Example 1, a first optical transmission line of Comparative Example 2, a first optical transmission line of Comparative Example 3, and a first optical transmission line of Example 1.

FIG. 5 is a schematic diagram of an experimental system of a transmission system using an optical transmission line.

FIG. 6A illustrates a relation between a modulation voltage and an error rate (BER).

FIG. 6B illustrates a relation between a modulation voltage and an error rate (BER).

FIG. 6C illustrates a relation between a modulation voltage and an error rate (BER).

FIG. 6D illustrates a relation between a modulation voltage and an error rate (BER).

FIG. 7A illustrates a noise intensity spectrum.

FIG. 7B illustrates a noise intensity spectrum.

FIG. 7C illustrates a noise intensity spectrum.

FIG. 7D illustrates a noise intensity spectrum.

FIG. 8 illustrates an example of a relation between a gap width and a return loss.

FIG. 9 illustrates a relation between a return loss and an error rate (BER).

FIG. 10A illustrates return loss dependency of a noise intensity spectrum.

FIG. 10B illustrates return loss dependency of a noise intensity spectrum.

FIG. 10C illustrates return loss dependency of a noise intensity spectrum.

FIG. 10D illustrates return loss dependency of a noise intensity spectrum.

FIG. 11A illustrates return loss dependency of a noise intensity spectrum.

FIG. 11B illustrates return loss dependency of a noise intensity spectrum.

FIG. 11C illustrates return loss dependency of a noise intensity spectrum.

FIG. 11D illustrates return loss dependency of a noise intensity spectrum.

FIG. 12 is a schematic configuration diagram of an optical transmission line according to a second embodiment.

FIG. 13 is a cross-sectional view of a connection portion in FIG. 12.

FIG. 14 is a schematic configuration diagram of an optical transmission line according to a third embodiment.

FIG. 15 is a schematic configuration diagram of an optical transmission line according to a fourth embodiment.

FIG. 16 is a schematic configuration diagram of an optical transmission line according to a fifth embodiment.

FIG. 17 is a schematic configuration diagram of an optical transmission line according to a sixth embodiment.

### DESCRIPTION OF EMBODIMENTS

Embodiments of the present invention will be described in detail below with reference to the drawings. Note that the present invention is not limited by the embodiments.

### First Embodiment

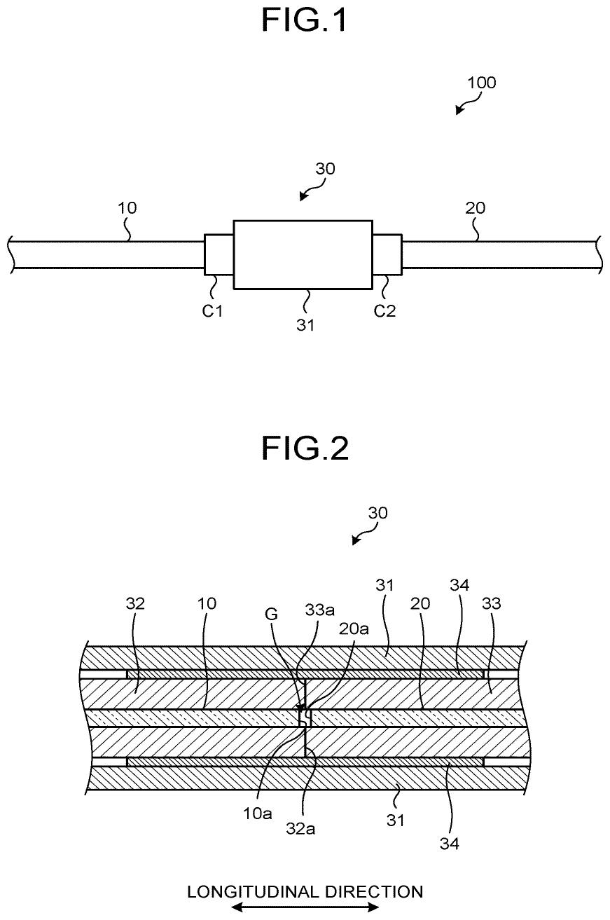

FIG. 1 is a schematic configuration diagram of an optical transmission line according to a first embodiment. An optical transmission line 100 is used in an optical transmission system, and includes a first optical transmission line 10, a second optical transmission line 20, and a connection portion 30.

The first optical transmission line 10 is an optical fiber made of glass such as quartz-based glass or a plastic optical fiber (POF), and is a multi-mode fiber (MMF). The first optical transmission line 10 may be of a graded-index (GI) type. Note, however, that, when the first optical transmission line has a sufficiently short length (e.g., several meters or less), a sufficient transmission band is secured, so that the GI distribution is unnecessary and a step-index (SI) type may be adopted. Furthermore, the first optical transmission line may have a shape of an optical waveguide, an optical fiber, or the like. The shape of the first optical transmission line is not particularly limited as long as scattering is controlled in the first optical transmission line as specified in the present invention. That is, the first optical transmission line may have a cross section of, for example, a circular, rectangular, or any other shape.

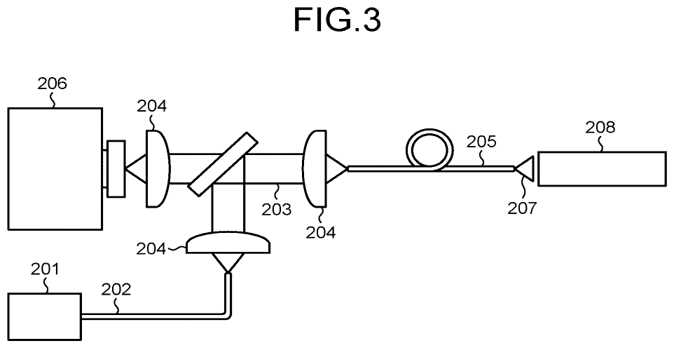

The first optical transmission line 10 has a scattering loss (e.g., scattering loss in wavelength of 850 nm) of an input optical signal of, for example, 50 dB/km or more, 60 dB/km or more, 65 dB/km or more, 70 dB/km or more, 100 dB/km or more, 200 dB/km or more, 500 dB/km or more, or 1000 dB/km or more. In the first optical transmission line 10 as described above, an optical signal is transmitted by forward scattering while accompanying mode coupling with a higher-order mode. As a result, the first optical transmission line 10 performs output while enlarging the beam diameter of the input optical signal by three times or more. Note that, when a Gaussian beam emitted from a single-mode optical fiber is input by center excitation, the first optical transmission line 10 as described above performs output while enlarging the beam diameter by three times or more (see evaluation in center excitation state in FIG. 3).

The second optical transmission line 20 is an MMF of the same type as the first optical transmission line 10, made of glass, such as quartz-based glass, and plastic. Therefore, the second optical transmission line 20 has a scattering loss (e.g., scattering loss in wavelength of 850 nm) of an input optical signal of, for example, 50 dB/km or more, 60 dB/km or more, 65 dB/km or more, 70 dB/km or more, 100 dB/km or more, 200 dB/km or more, 500 dB/km or more, or 1000 dB/km or more. When a Gaussian beam emitted from a single-mode optical fiber is input by center excitation, the second optical transmission line 20 as described above performs output while enlarging the beam diameter by three times or more. Furthermore, the second optical transmission line 20 may be longer or shorter than the first optical transmission line 10.

A connector C1 is provided at an end of the first optical transmission line 10. A connector C2 is provided at an end of the second optical transmission line 20. The connectors C1 and C2 are, for example, an SC connector, an FC connector, an ST connector, an LC connector, an MU connector, or an SMA 905 connector, and are not particularly limited. Any type of connector may be used.

The connection portion 30 optically connects the first optical transmission line 10 with the second optical transmission line 20. The connection portion 30 includes a connection adapter 31.

FIG. 2 is a cross-sectional view of the connection portion 30 in FIG. 1. The connection adapter 31 connects the connector C1 at the end of the first optical transmission line 10 with the connector C2 at the end of the second optical transmission line 20. The connection adapter 31 has a configuration in which a sleeve 34 for aligning ferrules is installed in an exterior. The sleeve 34 is, for example, a split sleeve. The exterior of the connection adapter 31 is fixed to exteriors of the connectors C1 and C2. The exterior of the connection adapter 31 and the exteriors of the connectors C1 and C2 are made of, for example, resin or metal. The sleeve 34 is made of, for example, metal or a ceramic such as zirconia.

The optical transmission line 100 includes a first ferrule 32 and a second ferrule 33 in the connection portion 30. The first ferrule 32 is fixed to the end of the first optical transmission line 10. The second ferrule 33 is fixed to the end of the second optical transmission line 20. The first ferrule 32 and the second ferrule 33 are made of, for example, resin, metal, or a ceramic such as zirconia.

A connection method of optically connecting the first optical transmission line 10 with the second optical transmission line 20 is as follows. That is, the end of the first optical transmission line 10 and the end of the second optical transmission line 20 are inserted into the connection adapter 31. The first ferrule 32 and the second ferrule 33 are inserted into the sleeve 34. Then, in the sleeve 34, an end surface 32a of the first ferrule 32 abuts on an end surface 33a of the second ferrule 33. This causes the first optical transmission line 10 and the second optical transmission line to be positioned such that optical axes thereof match each other. The first optical transmission line 10 and the second optical transmission line are optically connected by fixing the connector C1 and the connector C2 to the connection adapter 31.

In the above-described connection method, the first optical transmission line 10 and the second optical transmission line 20 are optically connected via a gap G in the connection portion 30. Specifically, an end surface 10a of the first optical transmission line 10 and the end surface 32a of the first ferrule 32 are misaligned in the longitudinal direction. The end surface 10a is located closer to the proximal end side (left side in figure) of the first optical transmission line 10 than the end surface 32a. Furthermore, an end surface 20a of the second optical transmission line 20 and the end surface 33a of the second ferrule 33 are misaligned in the longitudinal direction. The end surface 20a is located closer to the proximal end side (right side in figure) of the second optical transmission line 20 than the end surface 33a. This results in the gap G between the end surface 10a of the first optical transmission line 10 and the end surface 20a of the second optical transmission line 20 in a state where the end surface 32a of the first ferrule 32 abuts on the end surface 33a of the second ferrule 33.

Note that the difference between the position of the end surface 10a and the position of the end surface 32a in the longitudinal direction and the difference between the position of the end surface 20a and the position of the end surface 33a in the longitudinal direction are also referred to as pull-in amounts. The pull-in amounts can be adjusted by adjusting a polishing condition using the difference in hardness between the first optical transmission line 10 and the first ferrule 32 and the difference in hardness between the second optical transmission line 20 and the second ferrule 33 in a case where the end surface 10a, the end surface 32a, the end surface 20a, and the end surface 33a are buffed.

When the optical transmission line 100 is used as an optical transmission line in an optical transmission system, the optical transmission line 100 is disposed such that an optical signal is input from the side of the first optical transmission line 10. Therefore, for example, the first optical transmission line 10 is disposed immediately after a signal light source in the optical transmission system.

According to intensive studies of the present inventor, the optical transmission line 100 can achieve high-quality and large-capacity communication even if the first optical transmission line 10 and the second optical transmission line 20 are optically connected via the gap G. The reason is considered to be that, as described above, in the first optical transmission line 10, an optical signal is transmitted by forward scattering while accompanying mode coupling with a higher-order mode. Usually, a gap in the middle of an optical transmission line causes noise due to reflection of an optical signal. Strong mode coupling as generated in the first optical transmission line 10, however, is considered to change a field pattern, coherence, spatial distribution of polarized waves, and the like of light propagating in the transmission line, decrease interference of light, and inhibit noise (e.g., mode noise and reflected return light noise) caused by interference of light. Therefore, in the optical transmission system using the optical transmission line 100, reflection in the connection portion 30 is not necessarily considered to cause noise.

Therefore, according to the optical transmission line 100, a method of inhibiting reflection, such as PC connection, is not required to be used. Connectivity is thus improved, and high-quality and large-capacity communication can be achieved by a simple configuration.

Furthermore, in the optical transmission line 100, accuracy required for a pull-in amount and an end-surface state (flatness and angle) is mitigated as compared to that in a case where PC connection and the like are performed, which can greatly simplify a polishing process. Furthermore, in the optical transmission line 100, as compared to a case where PC connection and the like are performed, the first optical transmission line 10 and the second optical transmission line 20 are not required to be pressed against each other, and thus strong fitting force is unnecessary, which improves connection workability. Furthermore, since, in the optical transmission line 100, the end surface of the first optical transmission line 10 is not in direct contact with the end surface of the second optical transmission line 20, the end surfaces can be prevented from being damaged by foreign substances and the like. Therefore, the optical transmission line 100 is excellent also from the viewpoint of end surface protection.

Note, however, that the first optical transmission line 10 having an excessively long length increases a loss of an optical signal caused by the first optical transmission line 10. Therefore, for example, in the first optical transmission line 10, the product of a scattering loss of an optical signal and the length is preferably 6 dB or less. Also in the second optical transmission line 20, the product of a scattering loss of an optical signal and the length is preferably 6 dB or less.

Furthermore, the first optical transmission line 10 and the second optical transmission line 20 may be of different types. For example, the second optical transmission line 20 may have a transmission loss (e. g., transmission loss at wavelength of 850 nm) of an optical signal of, for example, 100 dB/km or less, 70 dB/km or less, 65 dB/km or less, 60 dB/km or less, 50 dB/km or less, 10 dB/km or less, or 3 dB/km or less. The second optical transmission line 20 may have a core diameter of, for example, approximately 50 μm. The second optical transmission line 20 may have a numerical aperture (NA) of, for example, approximately 0.2. The second optical transmission line may be of a GI type. The second optical transmission line 20 may perform output while enlarging the beam diameter of the input optical signal by less than three times. When a Gaussian beam emitted from a single-mode optical fiber is input by center excitation, the second optical transmission line 20 as described above may perform output while enlarging the beam diameter by less than three times.

### (Formation of Micro-Heterogeneous Structure)

Next, a preferred example of the first optical transmission line 10 will be described in detail. For example, an optical fiber having, in the core, a micro-heterogeneous structure with a correlation length of approximately several hundreds of angstroms or more can increase forward scattering different from so-called Rayleigh scattering observed in an optical fiber made of quartz-based glass.

For example, a polymer chain having a molecular weight of several hundred thousand has a coiled structure, and has a radius of inertia of approximately several hundreds of angstroms. Moreover, polymer coils may be slightly associated with each other to form a large heterogeneous structure. In such a case, a correlation distance increases as derived from Debye scattering theory, and forward scattering further occurs, which contributes to mode coupling. Furthermore, the micro-heterogeneous structure can also be formed by a copolymer. In general, a copolymer has composition distribution, and forms heterogeneous structures more easily than a homopolymer. For example, monomer units of the same type are associated with each other. Although depending on a manufacturing condition of extrusion/molecular weight of polymer/heat history, such heterogeneous structures can mass-produce polymers having a specific micro-heterogeneous structure without a problem in use as long as an enthalpy relaxation phenomenon is effectively utilized and an appropriate metastable enthalpy state can be achieved. Quartz glass has no such micro-heterogeneous structure.

Adding particles into a polymer or glass is effective as a method of controlling scattering in addition to causing a polymer to have a micro-heterogeneous structure. When scattering is required to enable stronger mode coupling, it is effective to add submicron or micron-order particles with different refractive indices into a core. Candidates of the particles are not limited as long as the candidates are polymers constituting a core or particles having refractive indices different from that of a glass medium. Although examples of the candidates of the particles include metal particles such as iron, silicon particles, silica particles, and mineral particles such as calcium carbonate, these are not limitations. Larger micron-sized particles are desirable than nano-sized particles for these particles to enhance forward scattering. Instead of adding particles, forming microvoids has a similar effect, and acts effectively.

In an aspect of a GI-type POF, refractive index distribution is formed by radially changing the concentration of low-molecular-weight dopants having a refractive index different from that of a polymer matrix. The dopants have a size of approximately several to several tens of angstroms, and one molecule causes light scattering of a negligibly small intensity. Slight fluctuation of the dopant concentration on the order of approximately several hundreds to several thousands of angstroms, however, forms a micro-heterogeneous structure, and induces forward light scattering. This slight dopant fluctuation/association is caused by a slight difference in compatibility between the polymer matrix and the dopants. Therefore, control of a micro-heterogeneous structure by the dopant fluctuation/association is made possible by studying the difference in compatibility between the polymer and the dopants using a solubility parameter as a guideline, and mode coupling can be controlled. Furthermore, mode coupling caused by forward scattering can be controlled by a similar principle by adding not only a dopant for forming refractive index distribution but small molecules for forming a micro-heterogeneous structure.

For example, acrylic polymers interact in molecules and between molecules due to ester groups in the molecules. In contrast, a perfluorinated polymer such as dioxolane has no such ester groups. Therefore, the interaction in molecules and between molecules is smaller than that in the acrylic polymer. Both the polymers are, however, aggregates of molecular coils having a radius of inertia of several hundreds of angstroms. For example, in extrusion, relatively stable micro-heterogeneous structure control is possible.

### (Example of Polymers Used for First Optical Transmission Line)

Polymers constituting a core portion and a clad portion of the first optical transmission line 10 can be manufactured by a method known in the art. Examples of the method include subjecting a mixture of monomers to constitute the polymers to solution polymerization, bulk polymerization, emulsion polymerization, suspension polymerization, or the like. Among them, the bulk polymerization method is preferable from the viewpoint of preventing contamination of foreign substances and impurities.

Polymerization temperature in this case is not particularly limited. For example, approximately 80 to 150° C. is suitable. Reaction time can be appropriately adjusted in accordance with an amount and type of monomers, amounts of a polymerization initiator, a chain transfer agent, and the like to be described later, reaction temperature, and the like. Approximately 20 to 60 hours is suitable. These polymers may be manufactured simultaneously or continuously when the core portion and/or the clad portion is molded.

Examples of the polymers constituting the core portion include substances obtained by performing chlorine substitution, fluorine substitution, and deuterium substitution on a part of hydrogen atoms of C—H bonds of monomers including: ethyl methacrylate, n-propyl methacrylate, n-butyl methacrylate, ethyl acrylate, n-propyl acrylate, and n-butyl acrylate as (meth)acrylic acid ester-based compounds; styrene, α-methylstyrene, chlorostyrene, and bromostyrene as styrene-based compounds; vinyl acetate, vinyl benzoate, vinyl phenylacetate, and vinyl chloroacetate as vinyl esters; and N-n-butyl maleimide, N-tert-butyl maleimide, N-isopropyl maleimide, and N-cyclohexyl maleimide as maleimides. Stretching vibration between C—H bonds constituting the above-described polymers causes an absorption loss by the overtone at a light source wavelength of 850 nm, for example. When the first optical transmission line has a sufficiently short length such as several meters or less, however, the absorption loss may be negligible. In such a case, general polymers such as non-halogenated acryl or styrene may be used.

In manufacturing polymers, a polymerization initiator and/or a chain transfer agent is preferably used. Examples of the polymerization initiator include a usual radical initiator. Examples thereof include: peroxide-based compounds, such as benzoyl peroxide, t-butyl peroxy-2-ethylhexanoate, di-t-butyl peroxide, t-butyl peroxyisopropyl carbonate, and n-butyl 4,4,bis(t-butyl peroxy) valerate; and azo compounds such as 2,2′-azobisisobutyronitrile, 2,2′-azobis(2-methylbutyronitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate), and di-t-butyl-2,2′-azobis(2-methylpropionate). These may be used singly or in combination of two or more types. The polymerization initiator is suitably used at approximately 0.01 to 2% by weight of all the monomers.

The chain transfer agent is not particularly limited. A known chain transfer agent can be used. Examples thereof include alkyl mercaptans (e.g., n-butyl mercaptan, n-pentyl mercaptan, n-octyl mercaptan, n-lauryl mercaptan, and t-dodecyl mercaptan) and thiophenols (e.g., thiophenol, m-bromothiophenol, p-bromothiophenol, m-toluenethiol, and p-toluenethiol). Among them, alkyl mercaptans such as n-butyl mercaptan, n-octyl mercaptan, n-lauryl mercaptan, and t-dodecyl mercaptan are preferably used. Furthermore, a chain transfer agent obtained by substituting a deuterium atom or a fluorine atom for a hydrogen atom of a C—H bond may be used. These may be used singly or in combination of two or more types.

The chain transfer agent is usually used for appropriately adjusting a molecular weight in terms of molding and physical property. A chain transfer constant of the chain transfer agent for each monomer can be determined by an experiment with reference to, for example, POLYMER HANDBOOK THIRD EDITION (edited by J. BRANDRUP and E. H. IM M ERGUT and published by JOHN WILEY & SON) and “Experimental Method for Polymer Synthesis” (co-authored by Otsu Takayuki and Kinoshita Masayoshi, Kagaku-Dojin Publishing Company, INC, published in 47^{th} year in Showa era). Therefore, the type and addition amount thereof is preferably adjusted appropriately in accordance with the type and the like of a monomer in consideration of the chain transfer constant. Examples thereof include approximately 0.1 to 4 parts by weight of 100 parts by weight of all monomer components.

Polymers constituting the core portion and/or the clad portion suitably has a weight-average molecular weight in a range of approximately 50,000 to 300,000, and preferably in a range of approximately 100,000 to 250,000. This is to secure appropriate flexibility, transparency, and the like. The core portion and the clad portion may have different molecular weights for viscosity adjustment, for example. The weight-average molecular weight refers to a value in terms of polystyrene, which has been measured by gel permeation chromatography (GPC), for example.

A compounding agent, for example, a heat stabilization aid, a processing aid, a heat resistance improver, an antioxidant, and a light stabilizer may be compounded into polymers constituting the first optical transmission line 10 as necessary without impairing performance such as transparency and heat resistance of an optical fiber. These compounding agents can be used singly or in combination of two or more types. Examples of a method of mixing these compounds and monomers or polymers include a hot blending method, a cold blending method, and a solution mixing method.

### (Fluorine-Containing Polymer Used for First Optical Transmission Line)

When a fluorine-containing polymer (including perfluorinated material and partially fluorinated material) is used as a core material for the first optical transmission line 10, the fluorine-containing polymer can be synthesized by the following method.

### [Synthesis Example A] Method of Synthesizing Perfluorinated Material

In general, products having names of TEFRON-AF (DuPont de Nemours, Inc.), Hyflon AD (Solvay), and CYTOP (AGC Inc.) can be used as perfluorinated materials. Furthermore, a perfluorinated polymer copolymerized with tetrafluoroethylene or the like may be used for a main ring structure thereof. Furthermore, a perfluorinated polymer having a 20ioxolane skeleton can also be used. Next, a method of synthesizing the 20ioxolane skeleton will be described.

### <Synthesis of Perfluoro-4-Methyl-2-Methylene-1,3-Dioxolane>

A purified product of 2-carbomethyl-2-trifluoromethyl-4-methyl-1,3-dioxolane was obtained by dehydration condensation reaction of 2-chloro-1-propanol, 1-chloro-2-propanol, and methyl trifluoropyruvate. Next, perfluoro-4-methyl-2-methylene-1,3-dioxolane was fluorinated. Fluorination treatment was performed by using 1,1,2-trichlorotrifluoroethane as a solvent, causing nitrogen gas and fluorine gas to flow at constant flow rates, and slowly adding 2-carbomethyl-2-trifluoromethyl-4-methyl-1,3 -dioxolane, which has been prepared in advance, into a reaction tank under a nitrogen/fluorine atmosphere. Perfluoro-2,4-dimethyl-1,3-dioxolane-2-carboxylic acid was then obtained. The above-described distillate was neutralized with an aqueous solution of potassium hydroxide to obtain perfluoro-2,4-dimethyl-2-potassium carboxylate-1,3-dioxolane. Perfluoro-4-methyl-2-methylene-1,3-dioxolane was obtained by drying the potassium salt in a vacuum and further decomposing the salt under an argon atmosphere. Perfluoro-4-methyl-2-methylene-1,3-dioxolane obtained as described above and perfluoro benzoyl peroxide were put into a glass tube, and deaerated in a freezing/thawing vacuum machine. The glass tube was refilled with argon. The contents were heated for several hours. The contents become solid, and transparent polymers were obtained. An optical fiber was produced by using the polymers.

The fluorine-containing polymer (including perfluorinated material and partially fluorinated material) preferably has a viscosity in a molten state of 10³ to 10⁵ poise at a melting temperature of 200 to 300° C. Excessively high melt viscosity makes melt spinning difficult. In addition, excessively high melt viscosity prevents diffusion of dopants necessary for forming refractive index distribution, which makes it difficult to form the refractive index distribution. Furthermore, excessively low melt viscosity has a problem in practical use. That is, when a fluorine-containing polymer having an excessively low melt viscosity is used as an optical transmission body in an electronic device, an automobile, or the like, the fluorine-containing polymer is exposed to high temperature and softened. This decreases optical transmission performance.

The fluorine-containing polymer preferably has a number average molecular weight of 10,000 to 5000,000, and more preferably 50,000 to 1000,000. An excessively small molecular weight and an excessively large molecular weight are not preferable since the excessively small molecular weight may impair heat resistance and the excessively large molecular weight makes it difficult to form an optical transmission body having refractive index distribution.

### (Partially Chlorinated Polymer Used for First Optical Transmission Line)

When a partially chlorinated material is used as a core material for the first optical transmission line 10, the partially chlorinated material can be synthesized by a method similar to the above-described method of synthesizing a perfluorinated material, which is a common production method.

### [Synthesis Example B] Synthesis of Partially Chlorinated Material (see Japanese Patent No. 5419815)

Next, a method of producing a partially chlorinated material will be briefly described. Trichloroethyl methacrylate, cyclohexyl maleimide, and diphenyl sulfide are precisely weighed, and put into a glass container. Trichloroethyl methacrylate has been preliminarily distilled and purified. Cyclohexyl maleimide has been sublimated and purified. Diphenyl sulfide serves as a dopant of a refractive index imparting agent. Moreover, ditertiary butyl peroxide and normal lauryl mercaptan are added respectively as a polymerization initiator and a chain transfer agent in predetermined amounts for a concentration in the total weight. The solution is filtered by being sufficiently mixed and put into a glass polymerization container through a membrane filter having a pore size. Next, dissolved air is removed by a freeze deaeration method while argon gas is introduced into a glass polymerization tube containing the solution. The glass polymerization tube is put in an oven. The temperature of the polymerization container is increased while argon gas is introduced to polymerize a monomer. Polymerization reaction is completed by further increasing the temperature. The glass tube is opened to obtain a solidified transparent polymerization rod.

### (Dopant for Forming Refractive Index Distribution)

When the solubility parameter of dopants is equal to the solubility parameter of polymers and good compatibility is achieved, the dopants are uniformly arranged in a polymer matrix. In contrast, when the difference between the solubility parameter of dopants and the solubility parameter of polymers increases, the dopants tend to increasingly aggregate together, and a refractive index heterogeneous structure is formed by concentration distribution of the dopants. Micro concentration distribution of the dopants can be formed by adding not only general knowledge of a solubility parameter but local interaction (e.g., secondary electronic polarization between specific functional groups) between a dopant and a polymer. A substance having a higher refractive index than a perfluorinated polymer is usually used as a dopant for a perfluorinated core material. That is, a substance dopant substantially has no C—H bond for a reason similar to that of perfluorinated polymerization, and more preferably has a refractive index 0.05 or more larger than a perfluorinated polymer. A larger refractive index needs a smaller content of dopants necessary for forming desired refractive index distribution, which leads to a small decrease in glass transition temperature. As a result, heat resistance of an optical fiber is enhanced. Therefore, a 0.1 or more larger refractive index is particularly preferable.

An aromatic ring such as a benzene ring, a halogen atom such as chlorine, bromine, and iodine, and a low-molecular-weight compound, an oligomer, and a polymer including a bonding group such as an ether bond are preferable as dopants. A polymer having an excessively large molecular weight is, however, not preferable since a large molecular weight decreases compatibility with a perfluorinated polymer and, as a result, increases a light scattering loss. Furthermore, a compound reversely having an excessively small molecular weight is also not preferable since the excessively small molecular weight decreases the glass transition temperature of a mixture with fluorine-containing polymers and causes a decrease in heat resistance temperature of an optical fiber. Therefore, a dopant preferably has a number average molecular weight of 3×10² to 2×10³, and more preferably 3×10² to 1×10³.

Examples of a specific compound of a dopant include an oligomer of 5- to 8-mer of chlorotrifluoroethylene, an oligomer of 5- to 8-mer of dichlorodifluoroethylene, or an oligomer of 2- to 5-mer obtained by polymerizing a monomer (e.g., monomer including chlorine atom) which provides an oligomer having a high refractive index among monomers forming the perfluorinated polymer, as described in JP H8-5848 A.

In addition to a halogen-containing aliphatic compound such as the above-described oligomers, a halogenated aromatic hydrocarbon not containing a hydrogen atom bonded to a carbon atom, a halogen-containing polycyclic compound, and the like can be used. In particular, a fluorinated aromatic hydrocarbon containing only a fluorine atom as a halogen atom (or containing relatively small number of chlorine atoms as compared to fluorine atoms) and a fluorine-containing polycyclic compound are preferable in terms of compatibility with a fluorine-containing polymer. Furthermore, the halogenated aromatic hydrocarbon and the halogen-containing polycyclic compound more preferably do not have a functional group with polarity such as a carbonyl group and a cyano group.

Examples of such a halogenated aromatic hydrocarbon include a compound represented by an expression Φr−Zb [Φr is a b-valent fluorinated aromatic ring residue obtained by substituting fluorine atoms for all hydrogen atoms, and Z is a halogen atom other than fluorine, -Rf, —CO—Rf, —O—Rf, or —CN, where Rf is a perfluoroalkyl group, a polyfluoroperhaloalkyl group, or monovalent Φr, and b is an integer of zero or one or more]. Examples of the aromatic ring include a benzene ring and a naphthalene ring. The perfluoroalkyl group and the polyfluoroperhaloalkyl group of Rf preferably have a carbon number of five or less. A chlorine atom and a bromine atom are preferable as a halogen atom other than fluorine. Examples of a specific compound include 1,3-dibromotetrafluorobenzene, 1,4-dibromotetrafluorobenzene, 2-bromotetrafluorobenzotrifluoride, clopentafluorobenzene, bromopentafluorobenzene, iodopentafluorobenzene, decafluorobenzophenone, perfluoroacetophenone, perfluorobiphenyl, chloroheptafluoronaphthalene, and bromoheptafluoronaphthalene. Examples of a dopant particularly preferred as an example of a fluorine-containing polycyclic compound include a chlorotrifluoroethylene oligomer, perfluoro (triphenyltriazine), perfluoroterphenyl, perfluoroquatrophenyl, perfluoro (triphenylbenzene), and perfluoroanthracene since these fluorine-containing polycyclic compounds have good compatibility with a perfluorinated polymer, particularly, a fluorine-containing polymer having a ring structure in a main chain and have good heat resistance. The good compatibility enables a fluorine-containing polymer, particularly, a fluorine-containing polymer having a ring structure in a main chain and a substance to be mixed to be mixed more easily by heating and melting the fluorine-containing polymer and the substance at 200 to 300° C. Furthermore, both can be uniformly mixed by dissolving both in a fluorine-containing solvent, mixing both, and removing the solvent.

Examples of a dopant used for a partially chlorinated or partially fluorinated core material include a low-molecular-weight compound and a compound obtained by substituting a deuterium atom for a hydrogen atom in the low-molecular-weight compound. Examples of a low-molecular-weight compound having a high refractive index include: sulfur compounds such as diphenylsulfone (DPSO) and a diphenylsulfone derivative (e.g., diphenylsulfone chloride such as 4,4′-dichlorodiphenylsulfone and 3,3′,4,4′-tetrachlorodiphenylsulfone), diphenyl sulfide (DPS), diphenylsulfoxide, dibenzothiophene, and a dithiane derivative; phosphate compound such as triphenyl phosphate (TPP) and tricresyl phosphate; benzyl benzoate; benzyl n-butyl phthalate; diphenyl phthalate; biphenyl; and diphenylmethane. Examples of a low-molecular-weight compound having a low refractive index include tris-2-ethylhexyl phosphate (TOP). These may be used singly or in combination of two or more types.

### (Method of Manufacturing First Optical Transmission Line)

In order to make it easy to form a micro-heterogeneous structure, temperature and pull-out temperature at the time of spinning an optical fiber may be controlled. A preform method and a melt extrusion method are well known as a common method of producing an optical fiber using a fluorine-containing polymer. In the preform method, a core and a rod-shaped plastic molded body called a clad rod are preliminarily produced. The core rod is disposed at the center. The clad rod has a hollow portion. The clad rod is integrated with the core rod so as to cover an outer peripheral portion of the core. A rod-shaped object called a preform is thus produced. In the method, the preform is set in a common spinning device. An outer peripheral portion of the preform is uniformly heated and molten by a cylindrical heater or the like. A distal end portion is drawn and stretched at a constant speed to have a fiber shape. The end portion is cooled and wound. An optical fiber is then obtained.

In contrast, in the melt extrusion method, a polymer preliminarily mixed with a predetermined amount of dopant is used as a core polymer, and a polymer containing no dopant is used as a clad polymer. Common melt extrusion devices are filled with the core polymer and the clad polymer. The two extruders merge the molten polymers, and coextrude the molten polymers to discharge both the polymers from a nozzle. An optical fiber is then obtained. In general, an extruder including a screw may be used. The melt extrusion may be performed by a pressure of nitrogen gas or the like. Furthermore, a covering layer can be provided as necessary.

A micro-heterogeneous structure can also be formed by a heat treatment process after the molten core polymer and the molten clad polymer are coextruded. For example, when being rapidly cooled after the coextrusion, the polymers are vitrified while keeping a large volume before enthalpy relaxation of the polymers occurs. In contrast, when the heat treatment process is sufficiently performed near the glass transition temperature, the volume slightly decreases due to enthalpy relaxation. When the enthalpy relaxation is formed in a micro region, a so-called micro-heterogeneous structure is formed. Furthermore, when a stretch process is further added after the coextrusion, molecules of the molten and extruded fiber are oriented, and oriented birefringence occurs in accordance with the degree of orientation. The oriented birefringence occurs not only in a fiber axis direction. As a result, birefringence also occurs in a radial direction and a specific direction. The birefringence structure also promotes mode coupling.

A method known in the art can be used as a method of manufacturing an optical fiber of the present invention. For example, an interfacial gel polymerization method, rotary polymerization, a melt extrusion dopant diffusion method, composite melt spinning, and a rod-in-tube method can be used for forming one or two or more layers of clad portions on the outer peripheries of one or two or more layers of core portions. Furthermore, a preform may be preliminarily formed, and stretched and drawn, for example.

Specific examples of the method include a method of producing a hollow clad portion and producing a core portion in the hollow portion of the clad portion. In this case, a monomer constituting the core portion is introduced into the hollow portion of the clad portion. A polymer is obtained by rotating the clad portion. The core portion having a higher refractive index than the clad portion is then formed. A core portion having one layer may be formed by performing the operation only once. A core portion having a plurality of layers may be formed by repeating the operation.

A cylindrical tube-shaped container (tube) made of glass, plastic, or metal can be used as a polymerization container. The polymerization container needs to have a mechanical strength against external force such as centrifugal force caused by rotation and heat resistance at the time of heat polymerization. Examples of a rotation speed of the polymerization container at the time of polymerization include approximately 500 to 3000 rpm. Usually, a monomer is preferably introduced into the polymerization container after the monomer is filtered through a filter to remove dust contained in the monomer.

Note that, for example, WO 93/08488 describes a method of imparting GI-type refractive index distribution in an optical fiber. In the method, a dopant is added at a constant monomer composition ratio, and a monomer is polymerized in bulk at an interface of a polymer. A rotary gel polymerization method and a charge composition ratio of monomers having different refractive indices are gradually changed. In the rotary gel polymerization method, interfacial gel polymerization that imparts the concentration distribution of the dopants in response to the reaction or a reaction mechanism of the interfacial gel polymerization is performed by a rotary polymerization method. That is, a polymerization rate of the previous layer is controlled (polymerization rate is lowered). Polymerization is performed to form the next layer having a higher refractive index. Rotary polymerization is performed such that refractive index distribution gradually increases from the interface with the clad portion to the central portion.

Moreover, a method of forming a core portion and a clad portion by using two or more melt extruders, a multilayer die having two or more layers, and a multilayer spinning nozzle may be adopted. That is, polymers and the like constituting the core portion and the clad portion are heated and molten, and injected from individual flow paths to the multilayer die and the multilayer spinning nozzle. A fiber or a preform can be formed by extruding the core portion with the die and the nozzle, simultaneously extruding one or two or more layers of concentric clad portions on the outer periphery of the core portion, and integrating the clad portions with the core portion by welding.

Furthermore, examples of the method include a melt extrusion dopant diffusion method and an extrusion method. In the melt extrusion dopant diffusion method, after the core portion and the clad portion are formed by using the two or more melt extruders, the multilayer die having two or more layers, and the multilayer spinning nozzle, dopants are diffused toward a peripheral portion or a central portion in a subsequently provided heat treatment zone to impart the concentration distribution of the dopants. In the extrusion method, polymers having a changed dopant amount and the like are introduced into two or more melt extruders, and the core portion and/or the clad portion is extruded in a multilayer structure.

When SI-type refractive index distribution is imparted, rotary polymerization and the like are suitably performed while keeping a monomer composition ratio and/or a dopant addition amount constant from the beginning to the end. When a multistep-type refractive index distribution is imparted, it is preferable to control the polymerization rate of the previous layer (increase polymerization rate) and perform polymerization to form the next layer having a higher refractive index in rotary polymerization and the like.

### Example 1 and Comparative Examples 1, 2, and 3

Optical transmission lines of Example 1 and Comparative Examples 1,2, and 3 were prepared as follows, and transmission characteristics thereof were examined. In Example 1, a GI-POF produced by the above-described melt extrusion method was used as the first optical transmission line. The first optical transmission line of Example 1 has an optical time domain reflectometer (OTDR) loss measured by an OTDR at a wavelength of 850 nm of 120 dB/km, a core diameter of approximately 50 μm, and an NA of approximately 0.18. A first optical transmission line (Clear Curve OM4 manufactured by Corning Incorporated) of Comparative Example 1 is a commercially available quartz-based optical fiber, and has an OTDR loss at a wavelength of 850 nm of 2.3 dB/km, a core diameter of approximately 50 μm, and an NA of approximately 0.2. A first optical transmission line (Fontex50 manufactured by AGC Inc.) of Comparative Example 2 is a commercially available GI-POF, and has an OTDR loss at a wavelength of 850 nm of 48 dB/km, a core diameter of approximately 55 μm, and an NA of approximately 0.24. A first optical transmission line (GigaPOF-50SR manufactured by Chromis Fiberoptics, Inc.) of Comparative Example 3 is a commercially available GI-POF, and has an OTDR loss at a wavelength of 850 nm of 60 dB/km, a core diameter of approximately 50 μm, and an NA of approximately 0.19. Note that most of the above-described OTDR loss is considered to be caused by a scattering loss.

First, beam characteristics of outputs of the first optical transmission lines of Example 1 and Comparative Examples 1, 2, and 3 were measured.

FIG. 3 illustrates a method of measuring beam characteristics. A beam diameter is determined by measuring a near field pattern (NFP). That is, emitted light 203 (mode field diameter of 4.9 μm and Gaussian beam) from a pigtail (APC-polished) of a polarization maintaining single-mode optical fiber 202 of a distributed bragg reflector (DBR) laser 201 having a single frequency of a center wavelength of 850 nm was input to an optical transmission line 205 serving as a first transmission line by using a lens 204 via a half mirror. In this case, light is made to be input to a core center of an optical transmission line 205 via the lens 204 through microscopic observation using a CCD camera 206, and evaluation is performed under a center excitation condition. Then, an NFP of light 207 output from an end surface opposite to an input end surface of an optical transmission line 205 was measured by using an NFP measurement device 208 (NFP1006 manufactured by PRECISE GAUGES co., ltd.), and the beam diameter of the light output from the optical transmission line 205 was determined. Furthermore, the beam diameter of light output from the DBR laser 201 and input to the optical transmission line 205 was determined by measuring light output from the lens 204 of a measurement system in FIG. 3. Note that the beam diameter (D4σ width) is determined by using a secondary moment method from the NFP.

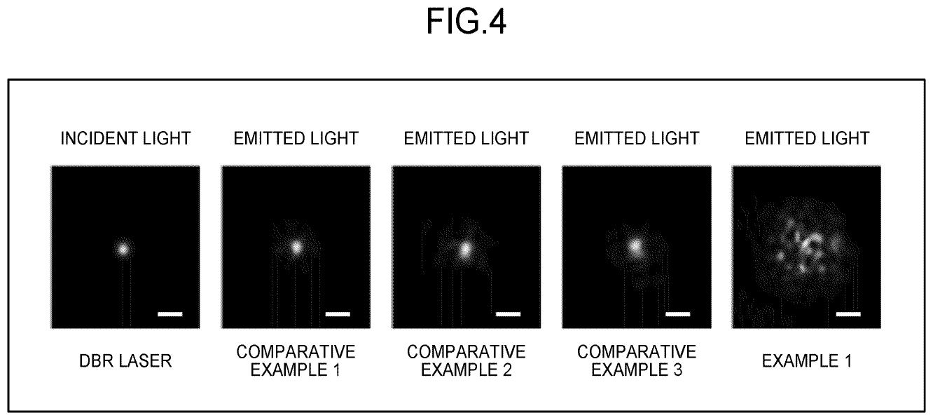

FIG. 4 illustrates measurement results of the beam characteristics of outputs of the DBR laser, the first optical transmission line of Comparative Example 1, the first optical transmission line of Comparative Example 2, the first optical transmission line of Comparative Example 3, and the first optical transmission line of Example 1. Note that all of the first optical transmission line of Comparative Example 1, the first optical transmission line of Comparative Example 2, the first optical transmission line of Comparative Example 3, and the first optical transmission line of Example 1 have a length of 1 m. Furthermore, white bars in the figure are scales having a length of 10 μm. As illustrated in FIG. 4, the first optical transmission lines of Comparative Examples 1, 2, and 3 perform output almost without enlarging the beam diameters of the input optical signals, that is, while enlarging the beam diameters by less than three times. Specifically, the first optical transmission line of Comparative Example 1 performs output while enlarging the beam diameter of the input optical signal by 1.9 times. The first optical transmission line of Comparative Example 2 performs output while enlarging the beam diameter of the input optical signal by 2.4 times. The first optical transmission line of Comparative Example 3 performs output while enlarging the beam diameter of the input optical signal by 2.4 times. In contrast, the first optical transmission line of Example 1 performs output while enlarging the beam diameter of the input optical signal by three times or more, specifically, 6.5 times.

Next, in order to conduct a transmission experiment, a second optical transmission line having a length of 10 m was connected to the first optical transmission line of Comparative Example 1 to form an optical transmission line of Comparative Example 1. Similarly, a second optical transmission line having a length of 10 m was connected to the first optical transmission line of Comparative Example 2 to form an optical transmission line of Comparative Example 2. Similarly, a second optical transmission line having a length of 10 m was connected to the first optical transmission line of Comparative Example 3 to form an optical transmission line of Comparative Example 3. Similarly, a second optical transmission line having a length of 10 m was connected to the first optical transmission line of Example 1 to form an optical transmission line of Example 1. Note that, in any case, the second optical transmission line was of the same type as the first optical transmission line, and had a different length. Then, optical signals were input and transmitted from the sides of the first optical transmission lines. The optical signals output from the sides of the second optical transmission lines were received by light receiving elements, and converted into electrical signals. The transmission characteristics of the optical transmission lines were then measured.

Specifically, as illustrated in an experimental system of a transmission system in FIG. 5, a connector C12 of an optical fiber F1 (first transmission line) having a length of 1 m was connected with a connector C21 of an optical fiber F2 (second optical transmission line) having a length of 10 m by an optical fiber connection portion C to form an optical transmission line. Connectors C11 and C12 are provided in the optical fiber F1. Connectors C21 and C22 were provided in the optical fiber F2. Then, an optical signal 302 from a light source 301 was collected on an end surface of the connector C11 by a lens 303, and was transmitted through the optical transmission line. The lens 303 was an aspherical lens. In the case, a limited mode excitation was set as an excitation condition. The optical fiber F1 was aligned so as not to cause a coupling loss other than a Fresnel reflection loss. Then, a lens system 305 including an aspherical lens collected an optical signal 304 emitted from the connector C22. A light receiver 306, which was a PD, received the optical signal 304. A BER was measured via a transimpedance amplifier.

In the case, BERs in a case where there was a gap having a width of 50 μm in the optical fiber connection portion C and in a case where there was no gap (i.e., optical fibers F1 and F2 (connectors C12 and C21) were pressed against each other and connected by PC) were compared/evaluated. In the case, the two optical fibers F1 and F2 were precisely aligned to eliminate axial misalignments in a radial direction and an angular direction. The measurement was then performed. Note that a case where there was a gap in the optical fiber connection portion C may be hereinafter referred to as non-PC connection.

A digital modulation method was adopted as a modulation method. That is, the optical signal was a non-return-to-zero (NRZ) signal of 10 Gbps, and had a pattern length of a pseudo random bit sequence (PRBS) of 2³¹-1. The light source 301 was a VCSEL having a wavelength of 850 nm, and had bias current of 5 mA. Center excitation was adopted as an excitation condition. Furthermore, a modulation voltage was changed from 0.12 to 0.40 V at 0.02 V intervals. BER measurement time was set to five minutes. PIN-PD made of GaAs was adopted as the light receiver 306. Furthermore, the VCSEL and the PD had bandwidths of 9 GHZ and 12 GHz, respectively. Furthermore, an antireflection coating was applied to the surfaces of the PD and the aspherical lenses so that Fresnel reflection thereon was made negligible.

Reflection generated in the optical fiber connection portion C was confirmed by measuring a return loss RL, which was defined in the following expression as the ratio of power Pin of light incident on the optical fiber connection portion C and power Pref of reflected light.

$$RL [ dB ] = 10 log ( Pin / Pref )$$

The return loss was measured by using an OTDR. The OTDR had an operating wavelength of 850 nm and a pulse width of 3 ns.

RL was 40 dB or more in all of Comparative Examples 1, 2, and 3 and Example 1 at the time of PC connection. Furthermore, at the time of non-PC connection with a gap width of 50 μm, RL was 11.4 dB in Comparative Example 1, 13.8 dB in Comparative Example 2, 13.8 dB in Comparative Example 3, and 13.8 dB in Example 1. These values were well matched with calculated values of return loss RL_{Fresnel} in a case where Fresnel reflection occurred in the optical fiber connection portion C. The return loss RL_{Fresnel} is represented by the following expression.

$${{RL}_{Fresnel} [ dB ] = - 10 log ( r + {r ( 1 - r )}^{2} / ( 1 - {r}^{2} ) ) , r = ( ( {n}_{1} - {n}_{2} ) / {n}_{1} + {n}_{2} ) )}^{2}$$

Here, n₁ is an effective group refractive index of a core, and n₂ is a refractive index of air. Return losses in Comparative Examples 2 and 3 and Example 1 are higher than that in Comparative Example 1. This is caused by refractive indices of optical fiber preforms in Comparative Examples 2 and 3 and Example 1 lower than that of a quartz glass and a low Fresnel reflectance on an optical fiber end surface.

In the experimental system, transmission quality may be deteriorated not only by reflection generated in the optical fiber connection portion C but by reflected return light generated on an end surface on the light emission side of the optical fiber F2 on the side of the light receiver 306. Therefore, in the measurement, in order to focus on the influence of the reflection generated in the optical fiber connection portion C, an end surface on the light emission side (end surface of connector C22) of the optical fiber F2 on the side of the light receiver 306 was obliquely polished at 12 degrees. This causes light reflected on the end surface of the connector C22 to be radiated to the outside of the core of the optical fiber F2, so that the influence of reflected return light generated on the end surface of the connector C22 can be removed. Note that the other end surfaces of the optical fibers (end surfaces of connectors C11, C12, and C21) are polished to have convex spherical surfaces. Therefore, the non-PC connection configuration having a gap between the connector C11 and the connector C21 was achieved by performing alignment using a commercially available alignment unit and adjustment of a gap width. In contrast, the PC connection configuration without a gap between the connector C11 and the connector C21 was achieved by performing connection using a commercially available optical fiber adapter.

Note that reflected return light from the connector C11 to the light source 301 hardly influences noise characteristics of the light source 301. This is because the distance between a VCSEL output surface of the light source 301 and the end surface of the connector C11 is extremely short, and a reciprocating propagation frequency of reflected return light from the vicinity of the VCSEL output surface as described above is on the order of several tens of gigahertzes and is larger than a relaxation vibration frequency (approximately 6 GHz) that gives an indication of the upper limit of a response speed of the VCSEL.

Furthermore, as described above, the gap width in the optical fiber connection portion C is 50 μm. The value is sufficiently shorter than the Rayleigh length of a beam output from each of the first optical transmission lines. As a result, in the optical fiber connection portion C, coupling losses other than Fresnel reflection are sufficiently small. Here, a Rayleigh length z_{R} of a multi-mode beam is defined as follows by using M² (also referred to as M² value or M2 factor) (T. F. Johnston and M. W. Sasnett, “Characterization of laserbeams: The M2 model”, in Handbook of Optical and Laser Scanning (CRC Press, 2012).).

$${Z}_{R} = π {W}^{2} / ( λ {M}^{2} ) , {M}^{2} = π W θ / λ$$

Here, W and θ are a beam radius and a divergence half-angle, respectively. Then, λ is a wavelength.

Note that, when the Rayleigh lengths z_{R} are calculated based on the core diameters and the Nas of the various optical fibers, the Rayleigh length z_{R} is calculated to be approximately 122 μm in Comparative Example 1, approximately 112 μm in Comparative Example 2, approximately 128 μm in Comparative Example 3, and approximately 138 μm in Example 1.

The gap width is preferably equal to or less than the Rayleigh length of a beam output from each of the first optical transmission lines, and more preferably equal to or less than ½ of the Rayleigh length. The gap width is, for example, several to several tens of micrometers. Note, however, that a smaller gap width is more preferable from the viewpoint of reducing a loss. For example, when a structure having a pull-in amount as illustrated in FIG. 2 is produced, the structure has a pull-in amount of, for example, approximately several micrometers.

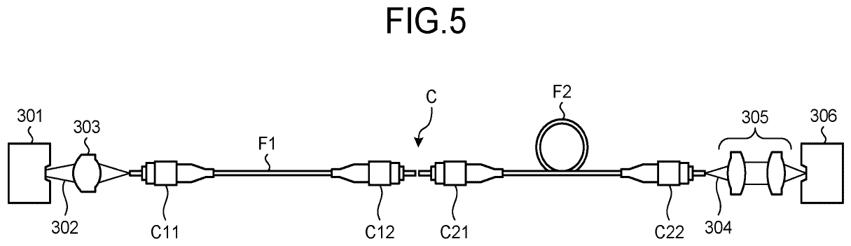

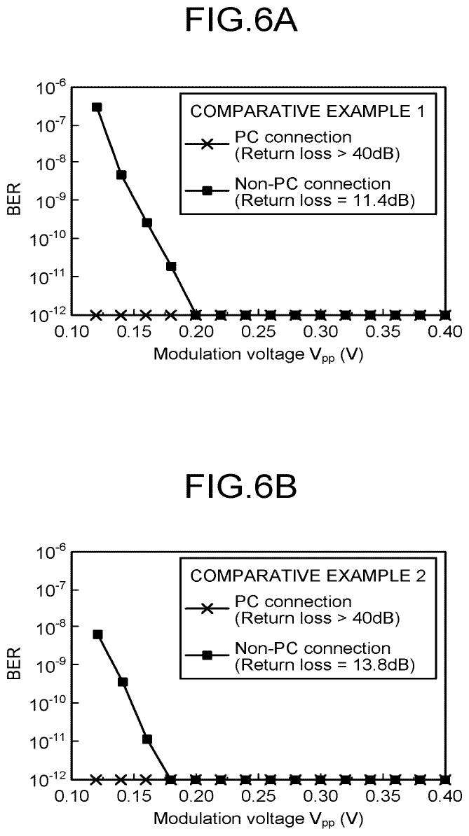

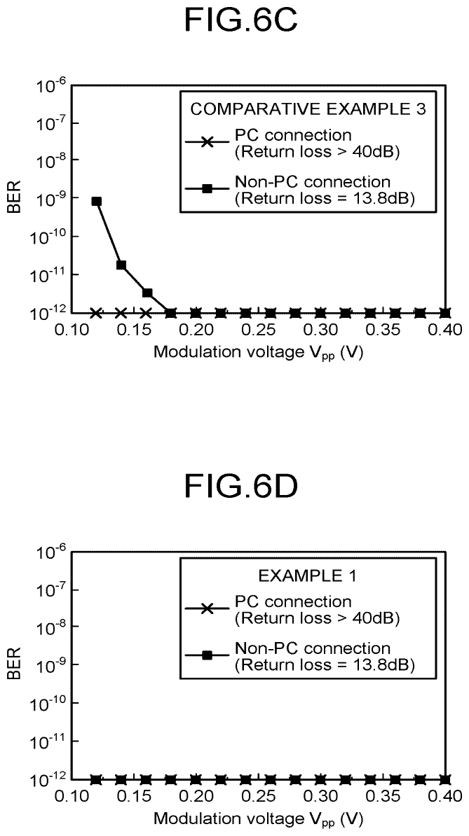

FIGS. 6A, 6B, 6C, and 6D illustrate a relation between a modulation voltage and an error rate (BER). Here, the transmission quality (BER) of the optical transmission system greatly depends on a condition of alignment of the light source 301 and the optical fiber F1 (first transmission line). Here, the light source 301 and the optical fiber F1 (first transmission line) were precisely aligned, and the worst values of the BER were compared and evaluated. FIG. 6A illustrates Comparative Example 1. FIG. 6B illustrates Comparative Example 2. FIG. 6C illustrates Comparative Example 3. FIG. 6D illustrates Example 1. Furthermore, “PC connection” indicates a case of PC connection. “Non-PC connection” indicates a case of non-PC connection.

As illustrated in FIGS. 6A, 6B, 6C, and 6D, error-free transmission of a BER of 10⁻¹² or less was achieved regardless of a modulation voltage in the case of PC connection in all of Comparative Example 1, Comparative Example 2, Comparative Example 3, and Example 1.

In the case of non-PC connection, however, the BER tended to deteriorate as a modulation voltage decreased in Comparative Examples 1, 2, and 3. Specifically, the BER increased up to approximately 10⁻⁶ in Comparative Example 1. The BER increased up to approximately 10⁻⁸ in Comparative Example 2. The BER increased up to approximately 10⁻⁹ in Comparative Example 3. In contrast, in Example 1, a BER of 10⁻⁹ or less was achieved at all measured modulation voltages regardless of whether there was a gap in the optical fiber connection portion C. The BER of 10⁻⁹ or less could not be achieved by the existing optical fibers in Comparative Examples 1 to 3. Moreover, in Example 1, a BER of 10⁻¹² or less, which was a requirement of the error-free transmission, was achieved at all the measured modulation voltages regardless of whether there was a gap in the optical fiber connection portion C. The above-described results indicate that the optical transmission system using the optical transmission line of Example 1 can achieve high-quality optical transmission without using a fitting technique for inhibiting reflection at an optical fiber connection portion, such as PC connection.

In particular, in Example 1, an error rate of 10⁻¹² or less is achieved without using an error correction method even though there is a gap. If the error rate of 10⁻¹² or less can be achieved without using an error correction method as described above, there do not arise problems of complication of a configuration caused by adding a processor such as a DSP in a case where the error correction method is used, transmission delay, a deterioration in encoding efficiency, heat generation caused by a load on a processor, and an increase in power consumption.

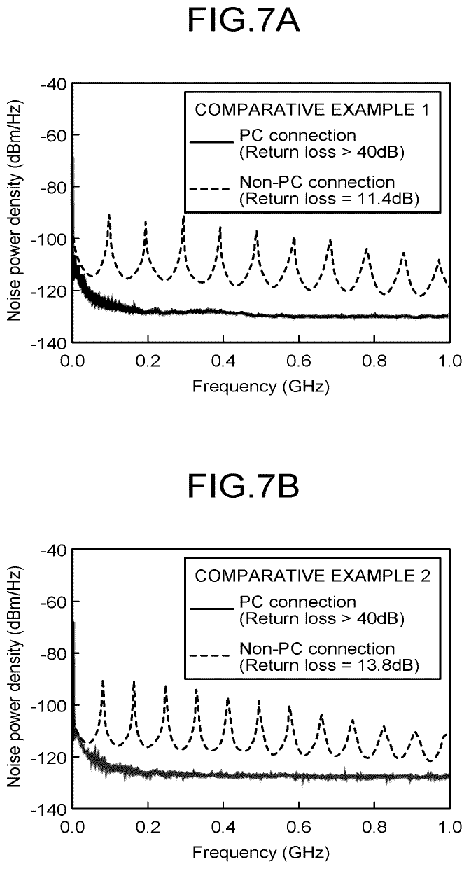

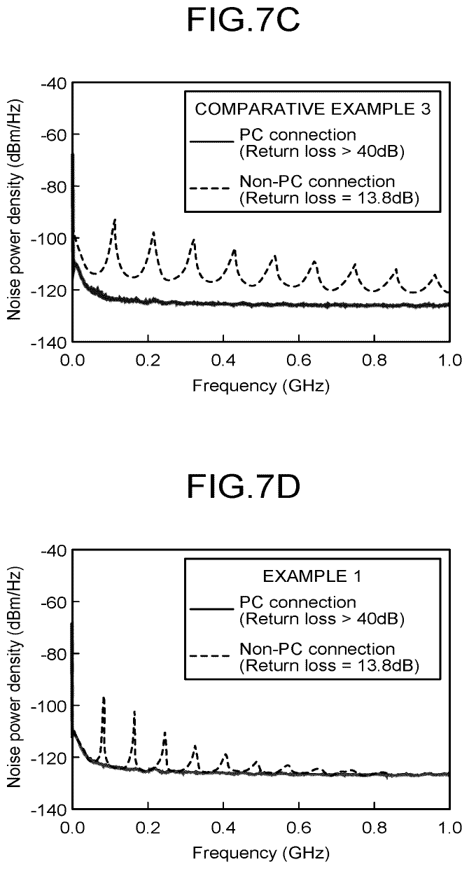

Next, FIGS. 7A, 7B, 7C, and 7D illustrate noise intensity spectra. Note, however, that the vertical axes indicate an intensity per unit bandwidth of noise. Furthermore, the noise intensity spectra were measured with light from the light source 301 being unmodulated in the experimental system in FIG. 5. FIG. 7A illustrates Comparative Example 1. FIG. 7B illustrates Comparative Example 2. FIG. 7C illustrates Comparative Example 3. FIG. 7D illustrates Example 1.

As illustrated in FIGS. 7A, 7B, 7C, and 7D, in all of Comparative Example 1, Comparative Example 2, Comparative Example 3, and Example 1, in the case of PC connection, spectral characteristics of approximately −126 dBm/Hz were obtained. In the spectral characteristics, the minimum value of the noise intensity is −125 dBm/Hz or less at 0 to 1 GHz.

In the non-PC connection, however, in Comparative Examples 1, 2, and 3, periodic peaks occurred at intervals of approximately 100 MHz. The minimum value of the noise intensity tended to increase to, at 0 to 1 GHZ, approximately −121.9 dBm/Hz (Comparative Example 1), approximately −121.8 dBm/Hz (Comparative Example 2), or approximately −121.6 dBm/Hz (Comparative Example 3). This is considered to be related to reflected return light noise caused by backward reflected light generated in the optical fiber connection portion C returning to the VCSEL. Note that the period of the periodic peaks matched the reciprocating propagation frequency of the reflected return light returning from the optical fiber connection portion C to the VCSEL.

In contrast, in Example 1, the number of noise peaks decreased as compared to those in Comparative Examples 1, 2, and 3. The minimum value of the noise intensity was approximately −127 dBm/Hz at 0 to 1 GHz, and an increase was hardly observed. This is because, in Example 1, strong mode coupling decreased a rate of recoupling of reflected return light with the VCSEL. This is considered to be a main mechanism in which stable data transmission can be achieved in Example 1 regardless of reflection in the optical fiber connection portion C.

### (Evaluation of BERs for Different Return Losses)

Next, BERs for different return losses were evaluated for further examining the influence of reflection in the optical fiber connection portion C. An optical signal was an NRZ signal of 10 Gbps, and had a pattern length of a PRBS of 2³¹-1. BER measurement time was set to five minutes. Furthermore, a modulation voltage was set to 0.12 V, which corresponded to the minimum signal level difference in multi-valued modulation (e.g., PAM4).

The connector C12 and the connector C21 were butt-connected by a commercially available optical fiber adapter. In the case, the optical fiber of the first optical transmission line and the optical fiber of the second optical transmission line were aligned by an alignment sleeve, so that axial misalignment between the optical fibers in a lateral direction and an angular direction can be neglected.

The return loss in the optical fiber connection portion C was changed by changing pressing force at the time of performing the butt-connection. When the optical fibers are butt-connected to each other, a slight gap on the order of a light wavelength may remain between the end surfaces of the optical fibers. The distance of the gap changes depending on pressing force against the optical fibers. A change in gap width changes an interference condition of multiple reflected light generated in the gap, which changes a return loss in the optical fiber connection portion C. Here, a return loss RL in consideration of multiple reflection in a minute gap can be expressed as in the following expression (M. Kihara, M. Uchino, M. Omachi, and H. Watanabe, J. Lightwave Technol. 31, 967 (2013).).

$${RL = 4 {r sin}^{2} ( 2 π {n}_{2} S / λ ) / ( {( 1 - r )}^{2} + 4 {r sin}^{2} ( 2 π {n}_{2} S / λ ) ) , r = ( ( {n}_{1} - {n}_{2} ) / {n}_{1} + {n}_{2} ) )}^{2}$$

Here, n₁ is an effective group refractive index of a core, n₂ is a refractive index of air, S is a gap width, and λ is a wavelength.

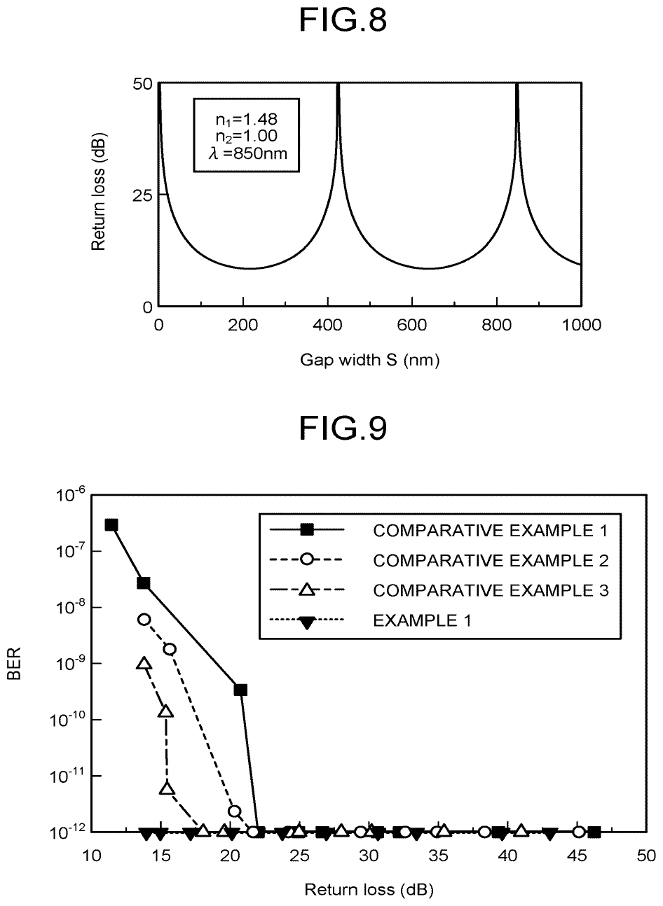

FIG. 8 illustrates an example of a relation between a gap width and a return loss. FIG. 8 illustrates a case where n₁ is 1.48, n₂ is 1.00, and λ is 850 nm.

FIG. 9 illustrates a relation between a return loss and a BER. As illustrated in FIG. 9, in Comparative Examples 1 and 2, error-free transmission of a BER of 10⁻¹² or less was obtained when the return loss was larger than approximately 22 dB. When the return loss was approximately 22 dB or less, however, the BER tended to deteriorate as the return loss decreased. Specifically, the BER increased up to approximately 10⁻⁶ in Comparative Example 1. The BER increased up to approximately 10⁻⁸ in Comparative Example 2. Furthermore, in Comparative Example 3, error-free transmission of a BER of 10⁻¹² or less was obtained when the return loss is larger than approximately 18 dB. When the return loss was approximately 18 dB or less, however, the BER tended to deteriorate as the return loss decreased. The BER increased up to approximately 10⁻⁹. This is considered to be because noise caused by reflection in the optical fiber connection portion C increases as the return loss decreases.

In contrast, in Example 1, a BER of 10⁻⁹ or less was achieved in all measured return losses (13.8 to approximately 43 dB) including cases of return losses of 18 dB or 22 dB or less. The BER of 10⁻⁹ cannot be achieved by existing optical fibers in Comparative Examples 1 to 3. Moreover, in Example 1, a BER of 10⁻¹² or less, which was a requirement of error-free transmission, was achieved in all measured return losses (13.8 to approximately 43 dB) including cases of return losses of 18 dB or 22 dB or less. The above-described results indicate that the optical transmission system using the optical transmission line of Example 1 has high resistance to reflection in the optical fiber connection portion C.

Here, a plurality of types of PC polishing is adopted for achieving PC connection in accordance with return losses to be guaranteed. For example, according to PC polishing, a return loss of 25 dB or more is guaranteed. According to Super PC (SPC) polishing, a return loss of 40 dB or more is guaranteed. According to Ultra PC (UPC) polishing, a return loss of 50 dB or more is guaranteed. According to Angled PC (APC) polishing, a return loss of 60 dB or more is guaranteed.

In contrast, in Example 1, error-free transmission was achieved even in the case of a return loss of 25 dB or less. It can thus be said that error-free transmission can be achieved without using various types of PC polishing.

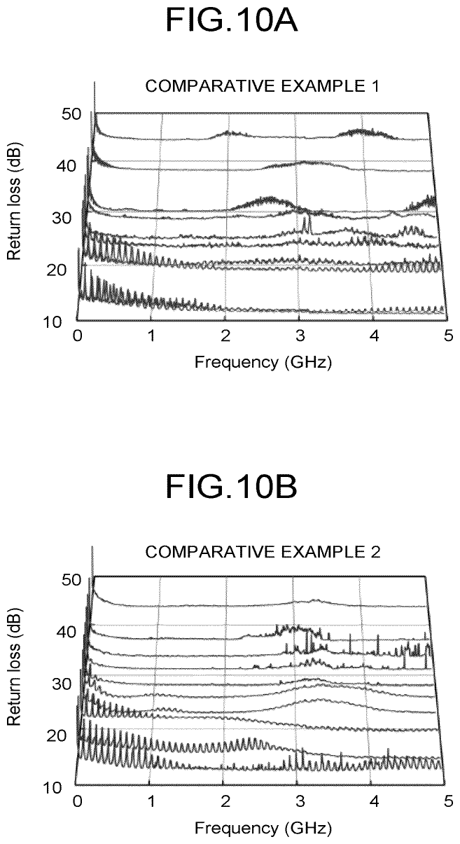

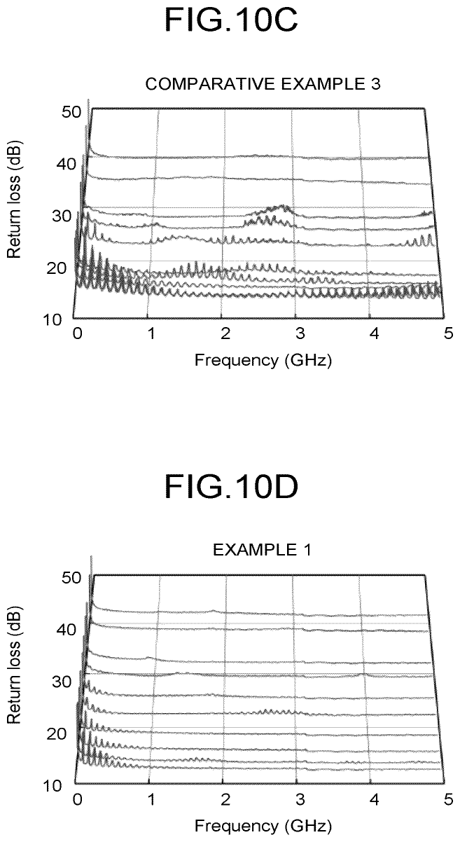

FIGS. 10A, 10B, 10C, and 10D illustrate return loss dependency of a noise intensity spectrum. FIG. 10A illustrates Comparative Example 1. FIG. 10B illustrates Comparative Example 2. FIG. 10C illustrates Comparative Example 3. FIG. 10D illustrates Example 1. In FIG. 10, horizontal axes represent a frequency, depths represent a return loss, and vertical axes represent a noise intensity per unit bandwidth (dBm/Hz). Note, however, that scales of the vertical axes are omitted.

The shape of the noise intensity spectrum was complicatedly changed depending on a return loss. This is considered to reflect the influence of destabilization due to reflection in the optical fiber connection portion C. When the return loss fell below 25 dB, periodic peaks tended to occur at intervals of approximately 100 MHz. As described above, the periodic peaks are considered to be noise caused by reflected return light.

In contrast, in Example 1, these periodic peaks were greatly reduced as compared to those in Comparative Examples 1, 2, and 3. Moreover, in Example 1, a smoother noise intensity spectrum was obtained as compared to those in Comparative Examples 1, 2, and 3. The above-described results indicate that noise caused by reflection in the optical fiber connection portion C is greatly reduced in Example 1.

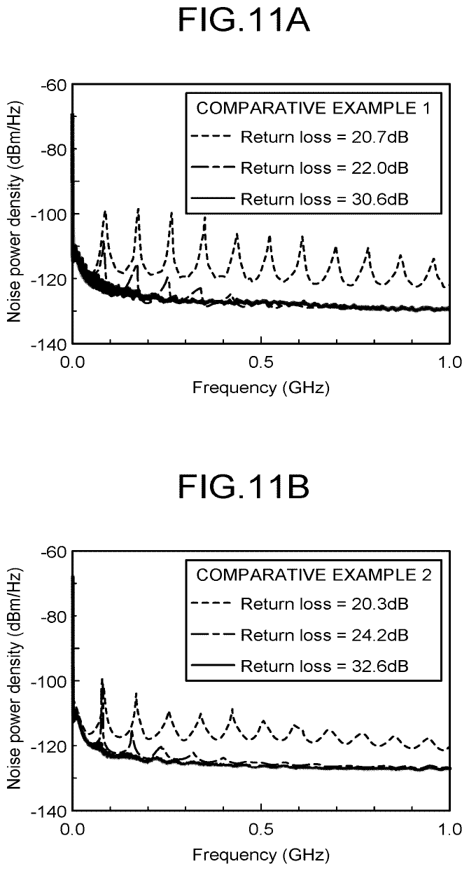

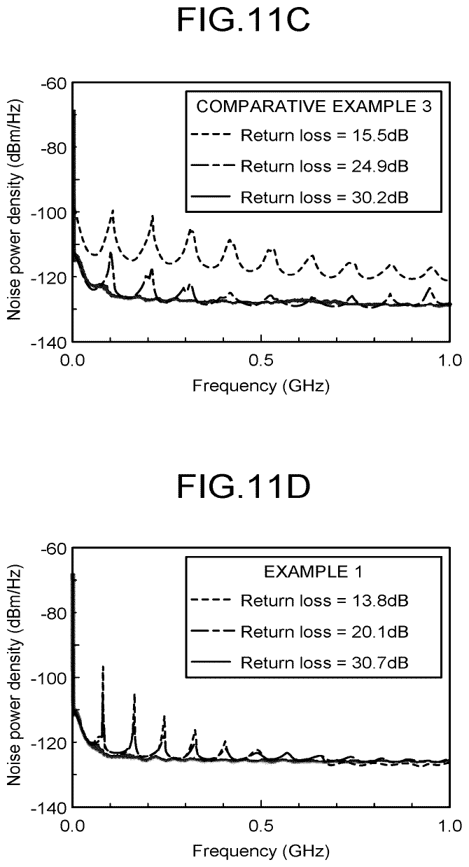

FIGS. 11A, 11B, 11C, and 11D illustrate the return loss dependency of a noise intensity spectrum, and are obtained by extracting ranges of a frequency of 0 to 1 GHz in FIGS. 10A, 11B, 11C, and 11D for some return losses. FIG. 11A illustrates Comparative Example 1. FIG. 11B illustrates Comparative Example 2. FIG. 11C illustrates Comparative Example 3. FIG. 11D illustrates Example 1.

When the return loss was larger than approximately 30 dB, a similar noise intensity spectrum was obtained in all of Comparative Examples 1, 2, and 3 and Example 1. Furthermore, when the return loss fell below approximately 30 dB, periodic peaks at intervals of approximately 100 MHz caused by reflected return light generated in the optical fiber connection portion C were observed.

In contrast, when the return loss reached approximately 20 dB, in Comparative Examples 1 and 2, a noise floor level tended to increase in addition to occurrence of the periodic peaks. The increase in the noise floor level is also considered to be related to the reflected return light generated in the optical fiber connection portion C. Furthermore, in Comparative Example 3, when the return loss reached 15.5 dB, the noise floor level tended to increase. The increase in the noise floor level was, however, not observed in Example 1 even when the return loss reached 13.8 dB. The above-described results also indicate that noise caused by reflection in the optical fiber connection portion C is reduced in Example 1.

### Second Embodiment

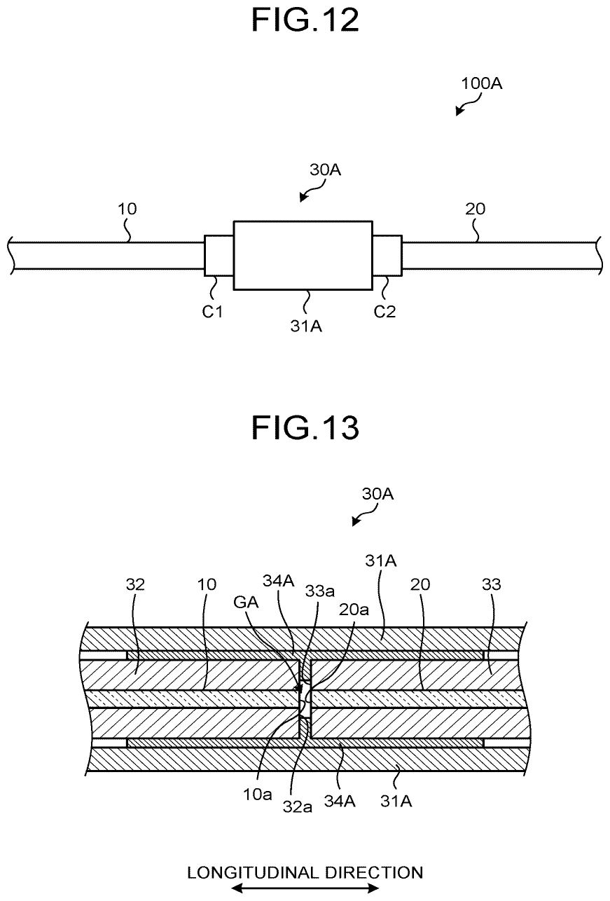

FIG. 12 is a schematic configuration diagram of an optical transmission line according to a second embodiment. An optical transmission line 100A is used in an optical transmission system, and includes a first optical transmission line 10, a second optical transmission line 20, and a connection portion 30A.

Since the first optical transmission line 10 and the second optical transmission line 20 are the same as the corresponding elements in the first embodiment, the description thereof will be omitted.

The connection portion 30A optically connects the first optical transmission line 10 with the second optical transmission line 20. The connection portion 30A includes a connection adapter 31A.

FIG. 13 is a cross-sectional view of the connection portion 30A in FIG. 12. The connection adapter 31A connects a connector C1 of the first optical transmission line 10 with a connector C2 of the second optical transmission line 20. The connection adapter 31A has a configuration in which a sleeve 34A for aligning ferrules is installed in an exterior. The exterior of the connection adapter 31A is fixed to exteriors of the connectors C1 and C2. The exterior of the connection adapter 31A is made of, for example, resin or metal. The sleeve 34A is made of, for example, metal or a ceramic such as zirconia.

The optical transmission line 100A includes a first ferrule 32 and a second ferrule 33 in the connection portion 30A. The first ferrule 32 is fixed to the end of the first optical transmission line 10. The second ferrule 33 is fixed to the end of the second optical transmission line 20.

The sleeve 34A also has a function of a spacer that separates the end surface 10a of the first optical transmission line 10 and the end surface 20a of the second optical transmission line 20 from each other. The sleeve 34A has, for example, a substantially cylindrical shape as a whole. An annular protrusion is formed on the inside of the sleeve 34A.

In the connection portion 30A, the end surface 32a of the first ferrule 32 and the end surface 10a of the first optical transmission line 10 are on the same plane, and the end surface 33a of the second ferrule 33 and the end surface 20a of the second optical transmission line 20 are on the same plane. A gap GA is, however, generated between the end surface 10a of the first optical transmission line 10 and the end surface 20a of the second optical transmission line 20 by the sleeve 34A.

According to the optical transmission line 100A configured as described above, similarly to the optical transmission line 100, a method of inhibiting reflection, such as PC connection, is not required to be used. Connectivity is thus improved, and high-quality and large-capacity communication can be achieved by a simple configuration. Furthermore, also in the optical transmission line 100A, similarly to the optical transmission line 100, a polishing process can be greatly simplified, and connection workability is improved, which is excellent from the viewpoint of end surface protection.

Note that the end surface 10a of the first optical transmission line 10 is not strictly required to be on the same plane as the end surface 32a of the first ferrule 32. The end surface 10a may slightly protrude toward the distal end side from the end surface 32a, or may be slightly pulled in toward the proximal end side. Similarly, the end surface 20a of the second optical transmission line 20 is not strictly required to be on the same plane as the end surface 33a of the second ferrule 33. The end surface 20a may slightly protrude toward the distal end side from the end surface 33a, or may be slightly pulled in toward the proximal end side. Such amounts of the protrusions that the end surface 10a of the first optical transmission line 10 and the end surface 20a of the second optical transmission line 20 are separated from each other by the sleeve 34A are required. A protrusion amount of, for example, approximately several micrometers is sufficient. Furthermore, for example, a pull-in amount of several micrometers is provided.

### Third Embodiment

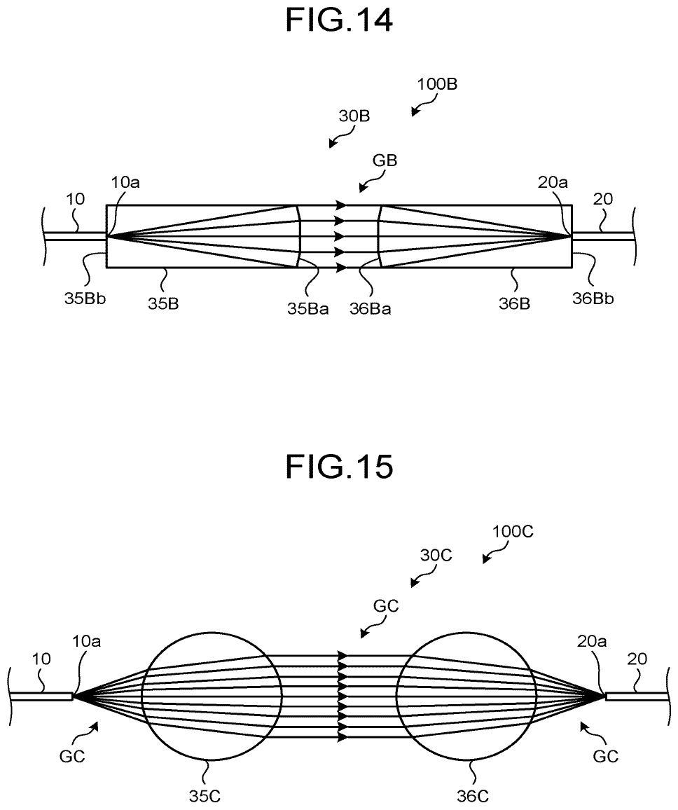

FIG. 14 is a schematic configuration diagram of an optical transmission line according to a third embodiment. An optical transmission line 100B is used in an optical transmission system, and includes a first optical transmission line 10, a second optical transmission line 20, and a connection portion 30B.

Since the first optical transmission line 10 and the second optical transmission line 20 are the same as the corresponding elements in the first embodiment, the description thereof will be omitted.

The connection portion 30B optically connects the first optical transmission line 10 with the second optical transmission line 20.

The optical transmission line 100B further includes lenses 35B and 36B in the connection portion 30B. The lenses 35B and 36B optically couple the first optical transmission line 10 with the second optical transmission line 20. The lenses 35B and 36B are planar-convex lenses disposed between the end surface 10a of the first optical transmission line 10 and the end surface 20a of the second optical transmission line 20. The lens 35B has a convex surface 35Ba and a flat surface 35Bb. The lens 36B has a convex surface 36Ba and a flat surface 36Bb. The convex surface 35Ba and the convex surface 36Ba face each other with a gap GB interposed therebetween. The flat surface 35Bb faces and abuts on the end surface 10a of the first optical transmission line 10. The flat surface 36Bb faces and abuts on the end surface 20a of the second optical transmission line 20.

The lens 35B enlarges a light beam of an optical signal output from the end surface 10a of the first optical transmission line 10, makes the light beam into substantially parallel light, and outputs the light. The lens 36B collects the optical signal made into the substantially parallel light by the lens 35B, and inputs the optical signal to the end surface 20a of the second optical transmission line 20.

A connection portion having a lens, such as the connection portion 30B, can be achieved by using, for example, a lens connector.

According to the optical transmission line 100B configured as described above, the lens 35B enlarges a light beam of an optical signal, which greatly improves the resistance of the first optical transmission line 10 and the second optical transmission line 20 against axial misalignment (or axial misalignment of lens connector). Furthermore, since the lenses 35B and 36B protect the end surface 10a of the first optical transmission line 10 and the end surface 20a of the second optical transmission line 20, the end surface 10a and the end surface 20a are not easily influenced by foreign substances such as dust.

Furthermore, similarly to the optical transmission line 100, according to the optical transmission line 100B, a method of inhibiting reflection, such as PC connection, is not required to be used. Connectivity is thus improved, and high-quality and large-capacity communication can be achieved by a simple configuration. Furthermore, also in the optical transmission line 100B, a polishing process can be greatly simplified, and connection workability is improved, which is excellent from the viewpoint of end surface protection.

Furthermore, since a reflection measure for a discontinuous surface in the optical transmission line, such as the surfaces of the lenses 35B and 36B, is unnecessary, designs of the lens and the lens connector can be simplified.

### Fourth Embodiment

FIG. 15 is a schematic configuration diagram of an optical transmission line according to a fourth embodiment. An optical transmission line 100C is used in an optical transmission system, and includes a first optical transmission line 10, a second optical transmission line 20, and a connection portion 30C.

The optical transmission line 100C has a configuration obtained by substituting the connection portion 30C for the connection portion 30B of the third embodiment in FIG. 14. The connection portion 30C optically connects the first optical transmission line 10 with the second optical transmission line 20, and has a configuration obtained by substituting lenses 35C and 36C for the lenses 35B and 36B of the connection portion 30B.

The lenses 35C and 36C are ball lenses disposed between the end surface 10a of the first optical transmission line 10 and the end surface 20a of the second optical transmission line 20. Gaps GC are formed between the end surface 10a and the lens 35C, between the lens 35C and the lens 36C, and between the lens 36C and the end surface 20a.

The lens 35C enlarges a light beam of an optical signal output from the end surface 10a of the first optical transmission line 10, makes the light beam into substantially parallel light, and outputs the light. The lens 36C collects the optical signal made into the substantially parallel light by the lens 35C, and inputs the optical signal to the end surface 20a of the second optical transmission line 20.

A connection portion having a lens such, as the connection portion 30C, can be achieved by using, for example, a lens connector.

According to the optical transmission line 100C configured as described above, advantageous effects similar to those of the optical transmission line 100B can be obtained.

### Fifth Embodiment

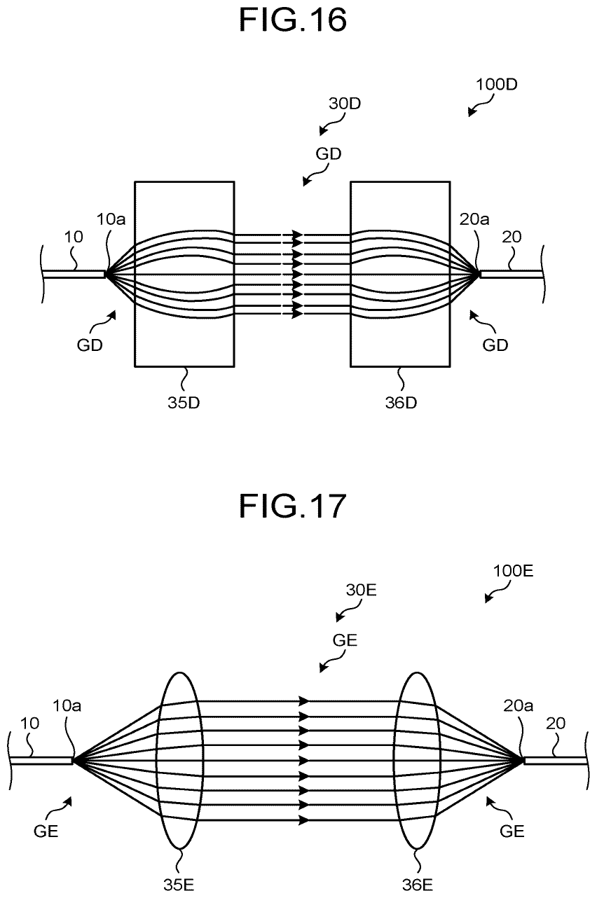

FIG. 16 is a schematic configuration diagram of an optical transmission line according to a fifth embodiment. An optical transmission line 100D is used in an optical transmission system, and includes a first optical transmission line 10, a second optical transmission line 20, and a connection portion 30D.

The optical transmission line 100D has a configuration obtained by substituting the connection portion 30D for the connection portion 30B of the third embodiment in FIG. 14. The connection portion 30D optically connects the first optical transmission line 10 with the second optical transmission line 20, and has a configuration obtained by substituting lenses 35D and 36D for the lenses 35B and 36B of the connection portion 30B.

The lenses 35D and 36D are GRIN lenses disposed between the end surface 10a of the first optical transmission line 10 and the end surface 20a of the second optical transmission line 20. Gaps GD are formed between the end surface 10a and the lens 35D, between the lens 35D and the lens 36D, and between the lens 36D and the end surface 20a.

The lens 35D enlarges a light beam of an optical signal output from the end surface 10a of the first optical transmission line 10, makes the light beam into substantially parallel light, and outputs the light. The lens 36D collects the optical signal made into the substantially parallel light by the lens 35D, and inputs the optical signal to the end surface 20a of the second optical transmission line 20.

A connection portion having a lens such, as the connection portion 30D, can be achieved by using, for example, a lens connector.

According to the optical transmission line 100D configured as described above, advantageous effects similar to those of the optical transmission line 100B can be obtained.

### Sixth Embodiment

FIG. 16 is a schematic configuration diagram of an optical transmission line according to a sixth embodiment. An optical transmission line 100E is used in an optical transmission system, and includes a first optical transmission line 10, a second optical transmission line 20, and a connection portion 30E.

The optical transmission line 100E has a configuration obtained by substituting the connection portion 30E for the connection portion 30B of the third embodiment in FIG. 14. The connection portion 30E optically connects the first optical transmission line 10 with the second optical transmission line 20, and has a configuration obtained by substituting lenses 35E and 36E for the lenses 35B and 36B of the connection portion 30B.

Here, 35E and 36E are biconvex lenses disposed between the end surface 10a of the first optical transmission line 10 and the end surface 20a of the second optical transmission line 20. Gaps GE are formed between the end surface 10a and the lens 35E, between the lens 35E and the lens 36E, and between the lens 36E and the end surface 20a.

The lens 35E enlarges a light beam of an optical signal output from the end surface 10a of the first optical transmission line 10, makes the light beam into substantially parallel light, and outputs the light. The lens 36E collects the optical signal made into the substantially parallel light by the lens 35E, and inputs the optical signal to the end surface 20a of the second optical transmission line 20.

A connection portion having a lens such, as the connection portion 30E, can be achieved by using, for example, a lens connector.

According to the optical transmission line 100E configured as described above, advantageous effects similar to those of the optical transmission line 100B can be obtained.

### (Multi-Valued Modulation and Application to Radio Over Fiber (RoF))

In recent years, in data centers and the like, a digital modulation method of a multi-valued modulation method such as four-valued pulse amplitude modulation (PAM4) has been introduced for expanding communication capacity. In PAM4, a transmission rate of twice as much as conventional NRZ transmission (binary modulation method) can be achieved by multi-valuing a signal level to four values. In contrast, there arises a major problem of a decrease in noise resistance accompanying multi-valuation of the signal level.

In contrast, an optical transmission system using the optical transmission lines according to the above-described embodiments and Example 1 can provide stable transmission even for low-amplitude data transmission. For example, in the case of the above-described experimental system, a typical modulation voltage (Vpp) of the NRZ transmission is approximately 0.35 to 0.40 V, and a modulation voltage corresponding to the minimum signal level difference of PAM4 is approximately 0.12 to 0.14 V. Here, as illustrated in FIG. 6D, in Example 1, not only in typical modulation voltage of NRZ transmission but in modulation voltage corresponding to the minimum signal level difference of PAM4, the BER is 10⁻⁹ or less, which is lower than those in Comparative Examples 1 to 3, and a BER of 10⁻¹² or less, which is a requirement of error-free transmission, is further achieved. Therefore, it is expected that a BER of 10⁻⁹ or less and a BER of 10⁻¹² or less can be achieved in Example 1 even when multi-valued modulation of PAM4 or more is adopted as a modulation method. Furthermore, also in relation to a modulation rate, a sufficient bandwidth is secured for a short-distance application (approximately 100 m or less) in a case of a GI-type optical fiber, so that any modulation rate including 10 Gbaud, 25 Gbaud, or more of a baud rate can be applied.

High-quality signal transmission achieved by the optical transmission lines according to the above-described embodiments and Example 1 can also be applied to RoF transmission in which a low-noise operation is similarly required. In RoF transmission, a light source is directly modulated by a wireless signal. A wireless signal waveform is converted into an optical signal waveform as it is. Transmission through an optical transmission line is then performed. This corresponds to analog modulation of an optical signal. In the RoF transmission, slight noise generated in an optical transmission line thus causes a deterioration in transmission quality. Examples of a method of a wireless signal used in the RoF transmission include an orthogonal frequency division multiplexing (OFDM) method. Examples of a modulation method include quadrature amplitude modulation (QAM).

### (Number of Connection Portions in Optical Transmission Line)

An optical transmission system may have a configuration in which three or more optical transmission lines are connected to form an optical transmission line. Correspondingly, the optical transmission line according to an embodiment of the present invention may further include a third optical transmission line in addition to the first optical transmission line and the second optical transmission line. The third optical transmission line is optically connected to the first optical transmission line, or optically connected to the second optical transmission line. The optical transmission line according to the embodiment of the present invention may include two third optical transmission lines. One of the third optical transmission lines may be optically connected to the first optical transmission line, and the other may be optically connected to the second optical transmission line. Moreover, the third optical transmission line may include one optical transmission line or two or more optical transmission lines optically connected to each other. Moreover, in the third optical transmission line, the two or more optical transmission lines optically connected to each other may be optically connected to each other at least one location via a gap, or may be optically connected to each other at all connection locations without a gap.

Here, when optical transmission lines are connected at a connection portion via a gap, Fresnel reflection loss generated on end surfaces of the optical transmission lines cannot be avoided, so that total optical loss of the optical transmission lines increases as the number of connection portions increases.

Loss (insertion loss: IL) per connection portion can be expressed by the following expression.

$${IL [ dB ] = - 10 log ( {( 1 - r )}^{2} / ( 1 - {r}^{2} ) ) , r = ( ( {n}_{1} - {n}_{2} ) / {n}_{1} + {n}_{2} ) )}^{2}$$

Here, n₁ is an effective group refractive index of a core, and n₂ is a refractive index of air. When calculation is performed by the above-described expression, an insertion loss of approximately 0.19 dB per connection portion occurs in the optical transmission line of Example 1. Note that, since the optical transmission line of Comparative Example 1 has a higher effective group refractive index than the optical transmission line of Example 1, the insertion loss per connection portion is approximately 0.33 dB. The optical transmission line of Example 1 has a smaller insertion loss per connection portion.

It is considered that, in the optical transmission system using the optical transmission line as in Example 1, when the optical transmission line has a loss of approximately 6 dB or less, an effect of noise reduction exceeds that of signal attenuation due to loss, and high-quality signal transmission can be achieved (see Patent Literature 1). The optical loss of the optical transmission line is influenced by a loss of the optical fiber itself, a loss of coupling between the optical fiber and a light source/light receiver, a loss of axial misalignment of a connection portion, and the like in addition to a connection loss of the connection portion. When the total of optical losses in the optical transmission line is within a range of approximately 6 dB or less, it is expected that high-quality optical transmission can be provided even if any number of one or more connection portions are provided in the optical transmission line.

Furthermore, when the third optical transmission line includes two or more optical transmission lines optically connected to each other, the two or more optical transmission lines may include different types of optical transmission lines or all the same type of optical transmission lines.

Note that the first to third optical transmission lines and the optical transmission line described above are not limited to optical fibers and optical waveguides, and may be collectively molded multi-optical transmission sheets as disclosed in WO 2019/177068.

Furthermore, the first to third optical transmission lines and the optical transmission line as described above have a single core, but may have multiple cores. In this case, a connection portion may have a structure of a multi-core connector such as an MPO connector.

Furthermore, the present invention is not limited by the above-described embodiments. The present invention also includes a configuration obtained by appropriately combining the above-described components. Furthermore, those skilled in the art can easily drive further effects and variations. Therefore, a wider aspect of the present invention is not limited to the above-described embodiments, and various changes can be made.

### REFERENCE SIGNS LIST

10 FIRST OPTICAL TRANSMISSION LINE
10a, 20a, 32a, 33a END SURFACE
20 SECOND OPTICAL TRANSMISSION LINE
30, 30A, 30B, 30C, 30D, 30E CONNECTION PORTION
31, 31A CONNECTION ADAPTER
32 FIRST FERRULE
33 SECOND FERRULE
34, 34A SLEEVE
35B, 35C, 35D, 35E, 36B, 36C, 36D, 36E, 204, 303 LENS
35Ba, 36Ba CONVEX SURFACE
35Bb, 36Bb FLAT SURFACE
100, 100A, 100B, 100C, 100D, 100E, 205 OPTICAL TRANSMISSION LINE
201 DBR LASER
202 POLARIZATION MAINTAINING SINGLE-MODE OPTICAL FIBER
203 EMITTED LIGHT
206 CCD CAMERA
207 LIGHT
208 NFP MEASUREMENT DEVICE
301 LIGHT SOURCE
302, 304 OPTICAL SIGNAL
305 LENS SYSTEM
306 LIGHT RECEIVER
C OPTICAL FIBER CONNECTION PORTION
C11, C12, C21, C22 CONNECTOR
F1, F2 OPTICAL FIBER
G, GA, GB, GC, GD, GE GAP

1. An optical transmission line comprising:
a first optical transmission line to which an optical signal having a predetermined wavelength is input;
a second optical transmission line; and
a connection portion that optically connects the first optical transmission line with the second optical transmission line,
wherein, when a product of a scattering loss of the optical signal and a length is 6 dB or less and a Gaussian beam emitted from a single-mode optical fiber is input by center excitation, the first optical transmission line performs output while enlarging a beam diameter by three times or more, and
in the connection portion, the first optical transmission line and the second optical transmission line are optically connected via a gap.

2. The optical transmission line according to claim 1,
wherein the second optical transmission line is longer than the first optical transmission line.

3. The optical transmission line according to claim 1,
wherein the first optical transmission line has a scattering loss of the optical signal of 65 dB/km or more.

4. The optical transmission line according to claim 1,
wherein, when a product of a scattering loss of the optical signal and a length is 6 dB or less and a Gaussian beam emitted from a single-mode optical fiber is input by center excitation, the second optical transmission line performs output while enlarging a beam diameter by three times or more.

5. The optical transmission line according to claim 1,
wherein, when a transmission loss of the optical signal is 65 dB/km or less and a Gaussian beam emitted from a single-mode optical fiber is input by center excitation, the second optical transmission line performs output while enlarging a beam diameter by less than three times.

6. The optical transmission line according to claim 1, further comprising
a third optical transmission line optically connected to the first optical transmission line or optically connected to the second optical transmission line,
wherein the third optical transmission line includes one optical transmission line or two or more optical transmission lines optically connected to each other.

7. The optical transmission line according to claim 6,
wherein, in the third optical transmission line, two or more optical transmission lines optically connected to each other are optically connected at one location via a gap.

8. The optical transmission line according to claim 1,
wherein the optical transmission line has a total optical loss of 6 dB or less.

9. The optical transmission line according to claim 6,
wherein the optical transmission line has a total optical loss of 6 dB or less.

10. The optical transmission line according to claim 1,
wherein the connection portion has a return loss of 25 dB or less.

11. The optical transmission line according to claim 1,
wherein a width of the gap in the connection portion is equal to or less than a Rayleigh length of a beam output from the first optical transmission line.

12. The optical transmission line according to claim 1, further comprising:
in the connection portion, a first ferrule fixed to an end of the first optical transmission line; and a second ferrule fixed to an end of the second optical transmission line,
wherein the gap is formed between the first optical transmission line and the second optical transmission line with the first ferrule and the second ferrule abutting on each other.

13. The optical transmission line according to claim 1, further comprising,
in the connection portion, a spacer that separates the first optical transmission line and the second optical transmission line from each other.

14. The optical transmission line according to claim 1, further comprising,
in the connection portion, a lens that optically couples the first optical transmission line with the second optical transmission line.

15. The optical transmission line according to claim 1,
wherein, when unmodulated light is input and transmitted from a side of the first optical transmission line and the unmodulated light output from a side of the second optical transmission line is received by a light receiving element and converted into an electrical signal, the electrical signal has a minimum value of a noise intensity spectrum of −125 dBm/Hz or less at a frequency of 0 to 1 GHz.

16. The optical transmission line according to claim 1,
wherein a digital modulation method is adopted as a method of modulating the optical signal, and, when the optical signal is input and transmitted from a side of the first optical transmission line and the optical signal output from a side of the second optical transmission line is received by a light receiving element and converted into an electrical signal, an error rate of 10⁻⁹ or less is achieved without using an error correction method.

17. The optical transmission line according to claim 1,
wherein a digital modulation method is adopted as a method of modulating the optical signal, and, when the optical signal is input and transmitted from a side of the first optical transmission line and the optical signal output from a side of the second optical transmission line is received by a light receiving element and converted into an electrical signal, an error rate of 10⁻¹² or less is achieved without using an error correction method.

18. An optical transmission system comprising the optical transmission line according to claim 1.

19. A method of optically connecting a first optical transmission line, to which an optical signal having a predetermined wavelength is input, with a second optical transmission line, the method comprising:
by the first optical transmission line, when a product of a scattering loss of the optical signal and a length is 6 dB or less and a Gaussian beam emitted from a single-mode optical fiber is input by center excitation, performing output while enlarging a beam diameter by three times or more; and
optically connecting the first optical transmission line with the second optical transmission line via a gap.

20. The optical transmission line according to claim 7,
wherein the optical transmission line has a total optical loss of 6 dB or less.
